(19) United States
(12) Patent Application Publication
(10) Pub. No.: US 2003/0018607 A1
(43) Pub. Date: Jan. 23, 2003

(54) Method of enabling browse and search access to electronically-accessible multimedia databases

(76) Inventors: Alison Joan Lennon, Balmain (AU); Sue-Ken Yap, Lane Cove (AU)

Correspondence Address: FITZPATRICK CELLA HARPER & SCINTO, 30 ROCKEFELLER PLAZA, NEW YORK, NY, 10112, US

(21) Appl. No.: 09/919,895

(22) Filed: Aug. 2, 2001

(30) Foreign Application Priority Data
Aug. 4, 2000 (AU) PQ9214

(51) Int. Cl. G06F 7/00

(52) U.S. Cl. 707/1

(57) ABSTRACT

A system is described including a media browser (101) for providing a user with a single user interface for browsing and searching different metadata collections over the Internet (102). A metadata server (212) is associated with each of the metadata collections. When the metadata server (212) receives a request, the metadata server (212) interprets the request and replies with a description that satisfies the request and according to a predetermined scheme. The description contains at least one link which represents a return link which represents a return request to the metadata server (212).

### FIELD OF THE INVENTION

The present invention relates generally to enabling access to electronically-accessible multimedia content and, in particular, to searching access which is mediated through a user interface.

### BACKGROUND

As network connectivity has continued its explosive growth, content providers are using the World Wide Web (the “Web”) to provide access to their multimedia content (eg. images, video, audio, etc.). Unlike textual content, such as HTML pages, multimedia content is not directly accessible to standard Web search engines. These search engines can examine sites on the Web and extract information about the textual content of those sites. Such information is typically termed “metadata” which is data that describes or catalogues aspects of other data. The extracted information (metadata) can then provide users with access to that content using their customised metadata databases.

In the case of multimedia, typically content providers or distributors store information about the multimedia items to which they have access in metadata databases. The content providers then enable access to these databases by providing a search engine that users or customers can access from a Web site, typically the content provider/distributor's own Web site. Customers wanting to purchase, or maybe view, content that a content provider/distributor has access to, can visit the Web site and use the search engine to search the content provider/distributor's metadata database. Typically the metadata database contains visual identifiers of the content (eg. thumbnails, video abstracts, audio previews, etc) as part of the metadata. The user can then make decisions about which item(s) they may wish to purchase/use based on the metadata that is returned from their searches.

In many cases the multimedia content is digital and on-line and potential customers can purchase the rights to use or purchase a copy of the desired multimedia item from the content provider/distributor's Web site. More often than not this transaction is completed on the Web site and the potential customer can directly download their newly acquired content. However this model of providing access to multimedia content does not require that the content is on-line. For example, a potential customer might be able to purchase the rights to use, or a copy, of the desired content from the Web site but the content may be delivered to the potential customer by non-electronic means (ie. the postal system). Another variation is that the potential customer may be redirected from a distributor's site to the actual content provider in order to purchase and acquire a copy of the desired content. Other variations include the potential customer being directed to a physical location to purchase the content and being posted books containing the metadata associated with items to be purchased.

In all the abovementioned situations, the potential customer can only gain access to the content to which each content provider/distributor has access. If the potential customer wanted to perform a search across several different content providers/distributors, he/she would have to visit the Web site and use the search engine of each of the different content providers/distributors. This is time consuming and annoying because the potential customer must use a different search engine interface each time.

These problems have encouraged the development of very large metadata databases on the Web where a content distributor either purchases the rights to content or simply acts as a distributor for smaller content providers. Examples of such are the large image databases of Getty and Corbus. This approach has its own problems. Firstly, the approach does not scale because as the databases become very large, the search time increases. Further, typically all the metadata has to be structured in a similar fashion in order to contain the same metadata keys. However, such is not always desirable as different metadata may be more appropriate depending on the targeted use of the content. For example, images captured for geological purposes would require different metadata that those captured for holiday brochures. Thirdly, smaller content providers have no way to directly sell their content (ie. they are effectively forced to use the larger distributors).

It is an object of the present invention to ameliorate one or more disadvantages of the prior art.

### SUMMARY OF THE INVENTION

In accordance with one aspect of the present invention there is disclosed a system for facilitating access to descriptions of multimedia items from a plurality of content providers of said items, wherein information required by said descriptions is stored in corresponding metadata collections associated with said multimedia items, said system comprising:

(a) a metadata server associated with each said content provider and operable as a description-generating process for communicating with one or more description-receiving processes, each said metadata server being configured, for each said content provider, to perform the steps of:

(i) receiving a request for said descriptions from one of said description-receiving processes in a predetermined request format;

(ii) interpreting said received request according to said predetermined request format;

(iii) accessing said information about said multimedia items in said metadata collection of said content provider in response to said interpreted request;

(iv) formatting said accessed information as a description according to a predetermined scheme, said resulting description containing at least one link which represents a return request to said metadata server;

(v) sending said formatted description to the said description-receiving process; and

(b) at least one said description-receiving process accessible to and operable by potential customers of said content providers and providing said potential customers with a single user interface to access descriptions of multimedia items generated from said multiple metadata servers.

In accordance with another aspect of the present disclosure there is provided a system for providing a plurality of users access to multimedia items associated with a plurality of content providers, each said content provider having a legacy database in which descriptions of corresponding said items are stored, a content database in which said corresponding multimedia items are stored, and a database manager for controlling access to said descriptions and corresponding multimedia items from said respective databases, said system comprising:

a media browser application accessible to each of said users and configured to generate user requests for descriptions of said multimedia items, said requests being generated in a predetermined request format;

a metadata server application associated with each said content provider and configured to translate each said user request received by said metadata server from said predetermined request format into a specific format of said database manager to thereby provide for said database manager to query said legacy database and return at least one response description to said metadata server, said metadata server translating said at least one response description into said predetermined description format and returning the translated description to the requesting said media browser for presentation to said user.

In accordance with another aspect of the present disclosure there is provided a system for facilitating access to structured information from a plurality of heterogeneous information sources, said system comprising:

(a) an information server associated with each said information source and operable as a structured information generating process for communicating with one or more structured information receiving processes, each information server being configured to perform, for an information source, the steps of:

(i) receiving a request for said structured information from one of said structured information receiving processes in a predetermined request format;

(ii) interpreting said received request according to said predetermined request format;

(iii) accessing information in said associated information source in response to said interpreted request;

(iv) formatting said accessed information as said structured information according to a predetermined scheme, said resulting structured information containing at least one link which represents a return request to said information server;

(v) sending said structured information to said structured information receiving process; and

(b) at least one structured information receiving process accessible to and operable by potential users of said information sources with a single user interface to access and interpret said structured information from said multiple information servers.

In accordance with another aspect of the present disclosure there is provided a metadata server operable as a description-generating process for communicating with one or more description-receiving processes, said metadata server being configured to perform the steps of:

(i) receiving a request for descriptions of multimedia items from one of said description-receiving processes in a predetermined request format, wherein information required by said descriptions is stored in corresponding metadata collections associated with said multimedia items;

(ii) interpreting said received request according to said predetermined request format;

(iii) accessing said information about said multimedia items in said metadata collection of said content provider in response to said interpreted request;

(iv) formatting said accessed information as a description according to a predetermined scheme, said resulting description containing at least one link which represents a return request to said metadata server; and

(v) sending said formatted description to the said description-receiving process.

In accordance with another aspect of the present disclosure there is provided an information server operable as a structured information generating process for communicating with one or more structured information receiving processes, said information server being configured to perform the steps of

(i) receiving a request for said structured information from one of said structured information receiving processes in a predetermined request format;

(ii) interpreting said received request according to said predetermined request format;

(iii) accessing information in response to said interpreted request;

(iv) formatting said accessed information as said structured information according to a predetermined scheme, said resulting structured information containing at least one link which represents a return request to said information server; and

(v) sending said structured information to said structured information receiving process.

Other aspects of the present invention are also disclosed.

### BRIEF DESCRIPTION OF THE DRAWINGS

One or more embodiments of the present invention will now be described with reference to the drawings in which:

FIG. 1 is a block diagram showing the operating environment of a multimedia access system;

FIG. 2 is a more detailed block diagram showing how the media browser accesses metadata databases;

FIG. 3 is a flow chart depicting the communication process between the media browser and the metadata server;

FIG. 4 shows the visual appearance of the user interface of the media browser component of the multimedia access system;

FIG. 5 is a flow chart showing the preferred browsing process of the media browser;

FIG. 6 is a flow chart showing the preferred searching process of the media browser;

FIG. 7 depicts a structured image metadata database;

FIG. 8 shows and example of an XML schema for browsing media resources;

FIG. 9 is a schematic block diagram representation of a computer system upon which the media browser may operate; and

FIG. 10 depicts an example implementation of the system of FIGS. 1 to 8.

### DETAILED DESCRIPTION

I. Overview

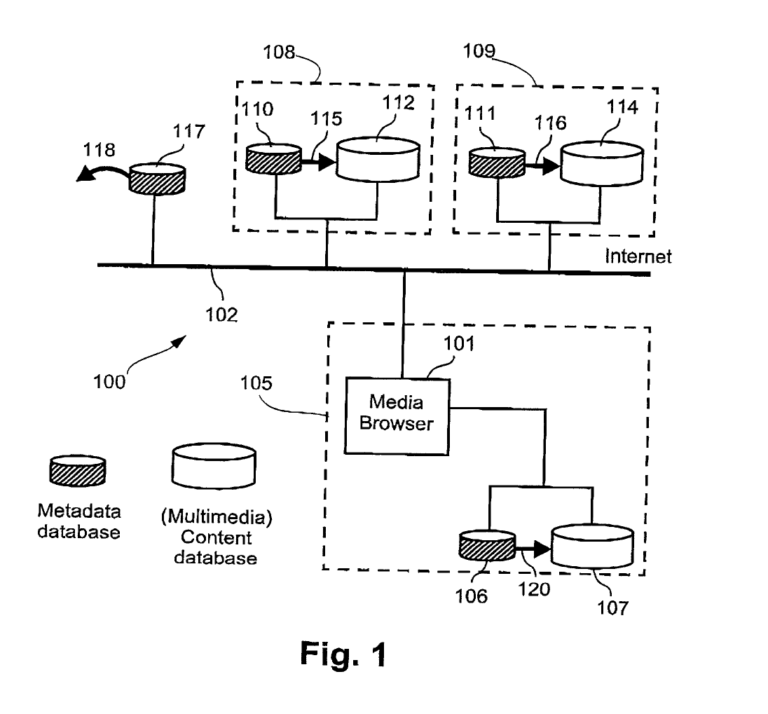

The operating environment of a multimedia access system is shown in FIG. 1. A computer system 100 is shown in which a computer application program, hereinafter called a media browser 101, operates on a local computer 105 to form a connection to a computer network, such as the Internet 102. As illustrated, the Internet 102 has associated therewith a number of server computers 108 and 109, each of which may host a number of Web sites and for each of which there is a corresponding store 112 and 114 in which multimedia content may be retained. The local computer 105 similarly may also have an associated store 107, although this is not essential to the implementation. The media browser application 101 provides a single user interface for a user to browse and search the system 100 for multimedia items using electronically-accessible metadata. In other words, the media browser 101 operates on metadata. Any playing/viewing of multimedia content is achieved by the use of plug-in media tools and is separated from the metadata-related processing. The media browser 101 is described in more detail in Section IV below.

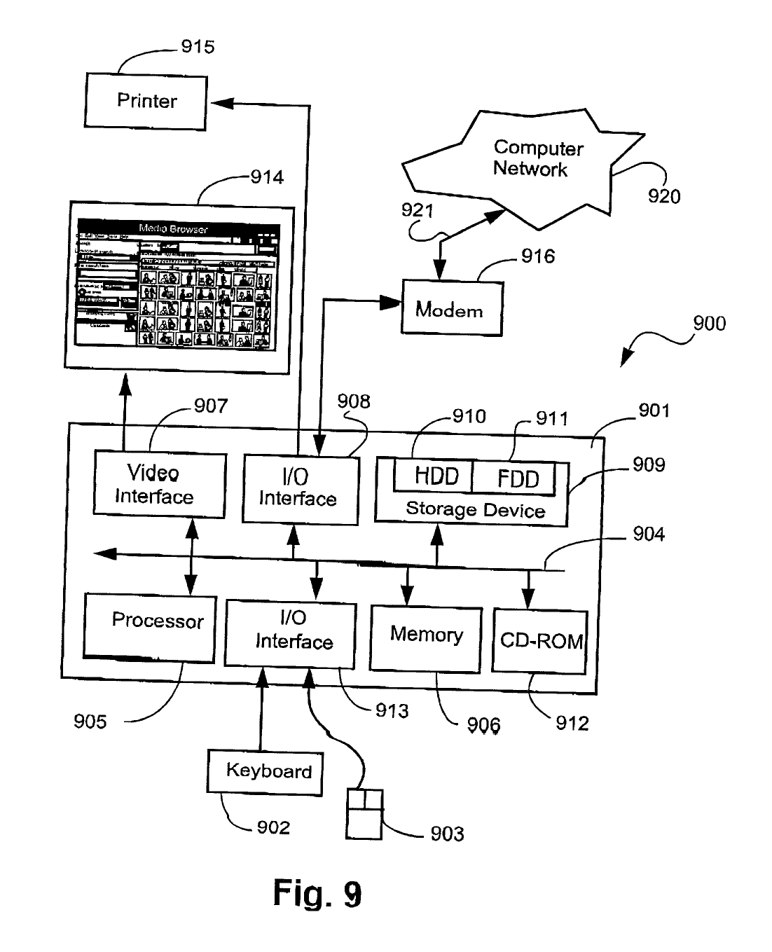

The described arrangements may practiced using a general-purpose computer system 900, such as that shown in FIG. 9 wherein the processes of FIG. 1 and to be described are implemented as software, such as an application program executing within the computer system 900. In particular, the method of media browsing is effected by instructions in the software that are carried out by the computer system. The software may be divided into essentially two separate parts; one part for executing the browsing and searching requests for particular metadata stores and another part to manage the user interface between the latter and the user. The software may be stored in one or more computer readable media, including the storage devices described below, for example. The software is loaded into computers of the system from the computer readable media, and then executed by the computers. A computer readable medium having such software or computer program recorded thereon is a computer program product. The use of the computer program product in a computer preferably effects an advantageous apparatus for media browsing.

The computer system 900 comprises a computer module 901, input devices such as a keyboard 902 and mouse 903, output devices including a printer 915 and a audio-visual output device 914. A Modulator-Demodulator (Modem) transceiver device 916 is used by the computer module 901 for communicating to and from a communications network 920, for example connectable via a telephone line 921 or other functional medium. The network 920 may for example be the Internet, and/or other network systems, such as a Local Area Network (LAN) or a Wide Area Network (WAN). Collectively, the devices 901-916 may form for example either one or any of the local computer 105 or server computers 108 and 109 of FIG. 1 and are often are described as computer workstations.

The computer module 901 typically includes at least one processor unit 905, a memory unit 906, for example formed from semiconductor random access memory (RAM) and read only memory (ROM), input/output (I/O) interfaces including a audio-visual interface 907, and an I/O interface 913 for the keyboard 902 and mouse 903 and optionally a joystick (not illustrated), and an interface 908 for the modem 916. A storage device 909 is provided and typically includes a hard disk drive 910 and a floppy disk drive 911. A magnetic tape drive (not illustrated) may also be used. A CD-ROM drive 912 is typically provided as a non-volatile source of data. The components 905 to 913 of the computer module 901, typically communicate via an interconnected bus 904 and in a manner which results in a conventional mode of operation of the computer system 900 known to those in the relevant art. Examples of computers on which the described arrangements can be practised include IBM-PC's and compatibles, Sun Sparcstations or alike computer systems evolved therefrom.

Typically, the application program is resident on the hard disk drive 910 and read and controlled in its execution by the processor 905. Intermediate storage of the program and any data fetched from the network 920 may be accomplished using the semiconductor memory 906, possibly in concert with the hard disk drive 910. The audio-visual output device 914 may be used to provide a graphical user interface to the application program by which user input may be afforded via the keyboard 902 and by clicking buttons on the mouse 903 as a mouse-cursor is manoeuvred across the interface represented on the audio-visual output device 914. In some instances, the application program may be supplied to the user encoded on a CD-ROM or floppy disk and read via the corresponding drive 912 or 911, or alternatively may be read by the user from the network 920 via the modem device 916. Still further, the software can also be loaded into the computer system 900 from other computer readable medium including magnetic tape, a ROM or integrated circuit, a magneto-optical disk, a radio or infra-red transmission channel between the computer module 901 and another device, a computer readable card such as a PCMCIA card, and the Internet and Itranets including e-mail transmissions and information recorded on websites and the like. The foregoing is merely exemplary of relevant computer readable media. Other computer readable media may be practiced without departing from the scope and spirit of the invention.

Returning to FIG. 1, the metadata used by the media browser 101 can be accessed directly from the local computer 105 or from any accessible site on the Internet 102 such as the server 108. Typically the metadata for a collection of multimedia content is stored in collections (eg. repositories or databases) with each item of content having at least one corresponding metadata item. As seen in FIG. 1, each content database or store 107, 112 and 114 has associated therewith a corresponding database 106, 110 and 111 respectively, which is configured to retain metadata items to facilitate access to the content within the corresponding respective content database or store 107, 112 and 114. Hereinafter, a metadata item is referred to as a description of its corresponding item (typically, of content) and the term metadata collection refers to collections of such descriptions.

In the preferred arrangement, the media browser 101 is able to access the metadata without having to access the content (107, 112, 114). In other words, a description is not stored as an integral part of an item of content. This means that the media browser 101 does not need to be able to directly interpret the large number of storage/transport formats for audiovisual content in order to access metadata.

The media browser 101 assumes that each description (in the databases 106, 110 and 111) has a link to its corresponding content in a content database or store (107, 112, 114). If the content is stored electronically, these links can be actuated or electronically followed (eg. 120, 115, 116) by a user or process. Alternatively links, such as the link 118, can describe a route to a non-electronic location (eg. a film archive). Non-electronic links are not active (ie. unable to be followed by a remote user or process) and hence are only informative of available content. Accordingly, wit such non-electronic links, remote users may not have a capacity to preview content using the media browser 101.

The media browser 101 requires that the metadata can be expressed in a standard manner. In the preferred arrangement, the syntax and structure of individual descriptions are determined by a schema. Descriptions of different items of content can use different schemas. Typically the schema used reflects the type of content and the typical use or purpose of the content. For example, a metadata schema for geological satellite images would most likely be significantly different to a schema for digital home video.

Schema may differ in their syntactical structure and the nature of the types of description components (hereinafter called descriptors). For example, a schema for digital home video may model descriptions of this type of content to contain a digital video tape, which contains one or more scenes, each of which contain one or more clips or shots. The geological satellite image schema may simply have a number of descriptors, with a particular geological focus, which are used to describe each image. In the preferred arrangement schemas are represented using the W3C Extensible Markup Language (XML) Schema language and individual descriptions are represented as XML documents. The metadata representation is described farther in Section II.

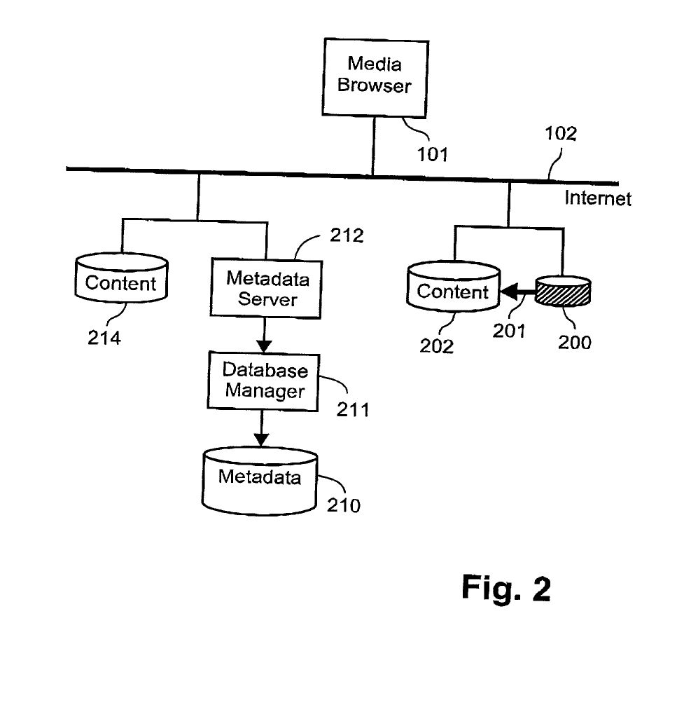

FIG. 2 shows an example of how a media browser 101 can access metadata over the Internet 102. All access to metadata is achieved using links with the target of each link being expressed as a Uniform Resource Identifier (URI). These links can be actuated either automatically by the media browser 101 or in response to a user action (eg. clicking on an item of interest).

In the case where the metadata is stored in an XML repository (collection of XML documents) 200, the media browser 101 can provide access to the metadata stored in the repository 200 using a link to an XML description of the repository 200. This description represents the structure of the repository 200 that is presented to a user of the media browser 101. The XML description is represented in the same way as a description of a multimedia item of content. In other words, the description preferably conforms to an XML schema that is accessible to the media browser 101, and which describes the structure of the repository 200. The XML description can contain links to other descriptions of particular sections of the repository 200 (in other words the description of the repository 200 does not need to be contained within a single XML document). Ultimately the repository XML description has links to descriptions of multimedia items. Each description of a multimedia item in the repository 200 contains a link 201 to a corresponding multimedia item in the corresponding content collection 202. This enables the media browser 101 to be able to retrieve these items if a user or customer selects to view or play the item based on the presented metadata.

In the case where access to a non-XML repository, here called a legacy database 210, is desired, the link described above with reference to FIG. 1 must operate through a server module called a metadata server 212. The metadata server 212 is typically located, though not necessarily, at the site of the metadata (ie. either local or remote) and is configured and controlled by the owner of the metadata. The purpose of the metadata server 212 is to effectively translate the metadata stored in a legacy database 210 to the format required by media browser 101. In other words, the metadata server 212 should preferably provide access to one or more schemas for the metadata and dynamically generate XML descriptions that conform to these schemas. Typically, a metadata server 212 needs only to provide schema definitions that describe the structure/syntax of the metadata collection, and the structure/syntax of the individual descriptions stored in the legacy database 210. These schema definitions may be contained in one or more XML Schema documents. As with the case where the remote metadata is stored in an XML repository 200, the descriptions of multimedia items, that the metadata server 212 generates, contain links to the corresponding multimedia items stored in a content collection 214 corresponding to the legacy database 210.

A link to a metadata server is also represented using a URI. The URI is composed of a network identifier component, which is a URI itself, and a query string which specifies details of the metadata server request. The request can be executed using a Hypertext Transfer Protocol (HTTP) get request over the Internet 102. Processing of the query results in descriptions of either the structure of the collection or multimedia items depending on how the metadata server 212 interprets the query string.

The descriptions that are dynamically generated by the metadata server 212 can be in response to media browser user browsing or search requests. Metadata servers are discussed further in Section III below.

II. Metadata Representation

The preferred arrangement assumes that all descriptions of multimedia items conform to a schema, and that schemas are expressed or represented using the W3C schema language, XML Schema. Individual descriptions are represented using XML document instances. XML Schema are also represented as XML documents. Therefore descriptions (eg. of multimedia items) can be stored along with their respective schemas in XML repositories or object stores. Alternatively, the descriptions can be stored in a database and effectively translated into XML documents when required.

Each description contains a reference to the schema to which it conforms. The reference is expressed using a URI (eg. http://somesite/schemas/DigitalVideoSchema.xsd). This means that once media browser has access to a description it can directly access to the schema or schemas to which the description conforms.

Technically, each XML element in a description (XML document) is declared to belong to a uniquely identified namespace. The XML document can then provide a hint to a processor, using the attribute schemaLocation (in the XMLSchema-instance namespace), for the location of a schema that contains definitions for a particular namespace. Hence an XML document, and thus also a description, indirectly rather than directly references one or more schemas.

In this document, the term “descriptor” is used to refer to a component, or atom, of a description. Each descriptor comprises a feature (descriptor name) and a value (description value). In some cases, the descriptor value comprises other descriptors, and thus may form a “complex descriptor”. In other cases, the descriptor value is a scalar value such as a string or date (ie. simple or atomic descriptors). In all cases media browser 101 assumes that descriptors are represented with the element (tag) name being the descriptor name and the content of the element being descriptor value. For example, a simple descriptor may use the textual content of the element (ie. the text between the tags) to represent the value of the descriptor (eg. a date, text string, enumeration, etc.).

This assumption about the structure of the metadata is not unlike how many practitioners currently use markup languages. In other words, it does not require significant changes from how practitioners might represent particular metadata vocabularies.

Some examples of descriptors are now provided. In the simple descriptor, <Photographer>John Smith</Photographer>, Photographer is the name of the descriptor and John Smith is the value of the descriptor. The type of the text of a simple descriptor can be constrained using the simple Type construct of XML Schema.

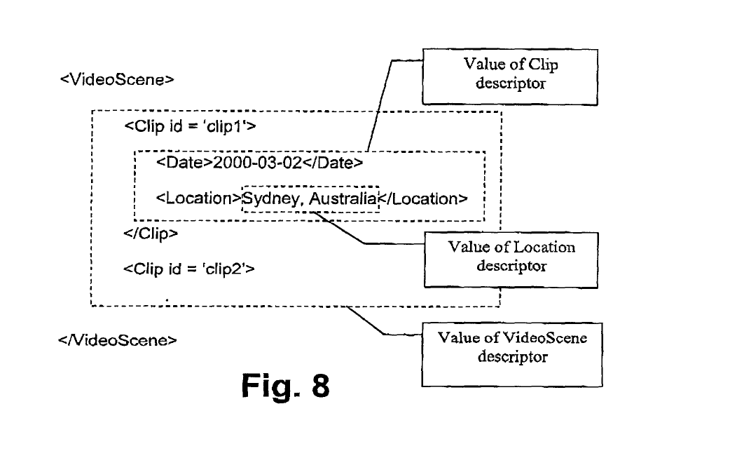

In the example shown in FIG. 8, both VideoScene and Clip are complex descriptors. The value of the VideoScene descriptor is the markup that is contained within the start and end tags of the descriptor. The name of the descriptor is the tag name (ie. VideoScene). Similarly the value of the Clip complex descriptor is that markup contained between the start and end tags of the Clip descriptor. The Clip descriptor value contains two simple descriptors, Date and Location. The value of the Location descriptor is the text contained between the start and end Location tags (ie. Sydney, Australia).

In order to be able to better interpret the basic semantics of descriptions for the purposes of visually presenting descriptions in a meaningful way to users, the preferred arrangement includes a core schema which contains definitions of a number of basic attributes that description schema designers can use when they define their descriptors. An example of the definitions included in this core schema are shown below as Example A, in which only a fragment of the actual schema is shown.

### EXAMPLE A:

| | |
|---|---|
| 1. | <simpleType name = ‘DescriptorType’> |
| 2. | <restriction base = ‘string’> |
| 3. | <enumeration value = ‘TOC’/> |
| 4. | <enumeration value = ‘Index’/> |
| 5. | <enumeration value = ‘Other’/> |
| 6. | </restriction> |
| 7. | </simpleType> |
| 8. | <attribute name = ‘id’ type = ‘ID’ /> |
| 9. | <attribute name = ‘textIdentifier’ type = ‘string’ /> |
| 10. | <attribute name = ‘visualIdentifier’ type = ‘anyURI’ /> |
| 11. | <attributeGroup name = ‘DescriptorAttributes’> |
| 12. | <attribute ref = ‘mb:id’ /> |
| 13. | <attribute ref = ‘mb:textIdentifier’ /> |
| 14. | <attribute ref = mb:visualIdentifier’ /> |
| 15. | <attribute name = ‘updateable’ type = ‘boolean’ default = |
| | ‘false’ /> |
| 16. | </attributeGroup> |
| 17. | <attributeGroup name = ‘TOCDescriptorAttributes’> |
| 18. | <attributeGroup ref = ‘mb:DescriptorAttributes’ /> |
| 19. | <attribute name = ‘descriptorType’ type = |
| | ‘mb:DescriptorType’ fixed = ‘TOC’ /> |
| 20. | </attributeGroup> |
| 21. | <attributeGroup name = ‘IndexDescriptorAttributes’> |
| 22. | <attributeGroup ref = ‘mb:DescriptorAttributes’ /> |
| 23. | <attribute name = ‘descriptorType’ type = |
| | ‘mb:DescriptorType’ fixed = ‘Index’/> |
| 24. | </attributeGroup> |

The attribute descriptorType is used to define whether a descriptor is to be treated as part of a Table of Contents (TOC descriptor), or as part of an index (index descriptor).

A TOC descriptor is used to describe the structure of a description, and is typically a complex descriptor. A TOC descriptor is navigable in the sense that such must contain a link within either its attributes or within the attributes of its children. The target of the link can be either a further description or an item of content. A TOC descriptor is similar to an entry in a table of contents of a book in that it enables a reader to go directly to a section of the work.

Index descriptors are typically leaf nodes of a hierarchically-composed descriptor structure and are often referred to as properties (ie. the type of descriptive information that is displayed using a properties dialog in a Microsoft Windows (registered trade mark) system. Section IV below describes how this attribute is used by the media browser.

Attributes are also used to contain visual and/or textual identifiers for a descriptor. A visual identifier (ie. visualIdentifier attribute) can be the URI of a thumbnail or movie/audio track preview. A text identifier (ie. textIdentifier attribute) can be used in the place of, or in addition to, a visual identifier. A text identifier typically contains a string value which describes the descriptor. In the absence of a visual identifier, the media browser can construct a visual representation based on this text value. These core attributes “drive” the user interface of the media browser. In other words, they have been included for presentation purposes.

In addition to the core visualisation attributes that are defined in the core schema, the preferred arrangement uses the linking attributes of the evolving W3C XLink standard (as described at http://www.w3.org/TR/xlink/) to provide linking semantics. XLink provides a framework for creating both basic unidirectional links, such as the HTML <A> linking element, and more complex linking structures. Simple linking elements are a common linking requirement for the preferred arrangement. These links can be used to represent links between two descriptors (ie. items of metadata) and links between descriptors (metadata) and content (eg. images, video, etc.). XLink also provides for other linking types such as extended links, locators and arc. The full list of linking types is described at http://www.w3.org/TR/xlink/.

The existence of a link, using XLink, is asserted by an XLink linking element. These elements need to be able to recognised by applications in order to provide appropriate display or behaviour. XLink uses a namespace to accomplish link recognition. The XLink namespace used by the preferred arrangement has the URI, http://www.w3.org/1999/xlink, and is associated with the xlink prefix. This association is achieved using the xmlns attribute of XML (eg. xmlns:xlink=‘http://www.w3.org/1999/xlink’). XLink's namespace provides definitions of global attributes that can be used on elements that are in any arbitrary namespace. These global attributes (xlink:type, xlink:href, xlink:role, xlink:title, xlink:show, xlink:actuate, xlink:from and xlink:to) can be used to make elements recognisable as linking elements. For example, if the value of the xlink:type attribute is set to “simple” for a particular element, then that element is treated as a simple linking element and the value of the attribute, xlink:href, contains the target of that link. For the purposes of this description, definitions of the linking attributes using XML schema are included below in Example B.

### EXAMPLE B:

| | |
|---|---|
| 1. | <?xml version = ‘1.0’?> |
| 2. | <schema |
| 3. | xmlns = ‘http://www.w3.org/2001/XMLSchema’ |
| 4. | xmlns:xlink = ‘http://www.w3.org/1999/xlink’ |
| 5. | targetNamespace = ‘http://www.w3.org/1999/xlink’ |
| 6. | attributeFormDefault = ‘qualified’ |
| 7. | version = ‘1.0’> |
| 8. | <simpleType name = ‘LinkType’> |
| 9. | <restriction base = ‘string’> |
| 10. | <enumeration value = ‘simple’/> |
| 11. | <enumeration value = ‘extended’/> |
| 12. | <enumeration value = ‘locator’/> |
| 13. | <enumeration value = ‘arc’/> |
| 14. | <enumeration value = ‘resource’/> |
| 15. | <enumeration value = ‘title’/> |
| 16. | <enumeration value = ‘none’/> |
| 17. | </restriction> |
| 18. | </simpleType> |
| 19. | <simpleType name = ‘ShowType’> |
| 20. | <restriction base = ‘string’> |
| 21. | <enumeration value = ‘new’/> |
| 22. | <enumeration value = ‘replace’/> |
| 23. | <enumeration value = ‘embed’/> |
| 24. | <enumeration value = ‘other’/> |
| 25. | <enumeration value = ‘none’/> |
| 26. | </restriction> |
| 27. | </simpleType> |
| 28. | <simpleType name = ‘ActuateType’> |
| 29. | <restriction base = ‘string’> |
| 30. | <enumeration value = ‘onLoad’/> |
| 31. | <enumeration value = ‘onRequest’/> |
| 32. | <enumeration value = ‘other’/> |
| 33. | <enumeration value = ‘none’/> |
| 34. | </restriction> |
| 35. | </simpleType> |
| 36. | <attribute name = ‘type’ type = ‘xlink:LinkType’ |
| | default = ‘simple’/> |
| 37. | <attribute name = ‘show’ type = ‘xlink:ShowType’ |
| | default = ‘new’/> |
| 38. | <attribute name = ‘role’ type = ‘QName’ |
| | default = ‘resource’/> |
| 39. | <attribute name = ‘actuate’ type = ‘xlinkActuateType’/> |
| 40. | <attribute name = ‘href’ type = ‘anyURI’/> |
| 41. | <attribute name = ‘arcrole’ type = ‘string’/> |
| 42. | <attribute name = ‘title’ type = ‘string’/> |
| 43. | <attribute name = ‘label’ type = ‘NMTOKEN’/> |
| 44. | <attribute name = ‘from’ type = ‘NMTOKEN’/> |
| 45. | <attribute name = ‘to’ type = ‘NMTOKEN’/> |
| 46. | </schema> |

A particular schema can use the core XLink and media browser attributes when declaring individual descriptors for a schema. In Example C below, the particular descriptors VideoClip, Date and Photographer are declared in a particular schema. Note that only a fragment of an actual schema is shown and reference to the media browser and XLink namespaces is assumed via the namespace prefixes mb and xlink, respectively. In XML Schema these namespace prefixes are assigned using the xmlns attribute of the XML Schema language. The media browser attributes are referenced unchanged from their definitions as seen at line 21 for TOCDescriptorAttributes. However one of the XLink attributes that are referenced, for example as seen at line 24, is further refined from its original definition. For example, the VideoClip descriptor is a simple linking element so the xlink:type attribute's value will assume the default value of “simple”. With a simple link, the element (descriptor) is the link source and a single linkend must exist. This single linkend is represented using the xlink:href attribute. A value must be supplied for this attribute for the simple link to be valid (hence the use constraint for this attribute is set to “required”). Note also that the xlink:href attribute for the VideoClip descriptor will assume its default value of “resource” (i.e. the target of the link should be assumed to be the item of content being described).

### EXAMPLE C:

| | |
|---|---|
| 1. | <element name = ‘VideoClip’> |

| | |
|---|---|
| 2. | <complexType> |

| | |
|---|---|
| 3. | <element name = ‘Date’> |

| | |
|---|---|
| 4. | <complexType> |

| | |
|---|---|
| 5. | <simpleContent> |

| | |
|---|---|
| 6. | <extension base = ‘date’> |

| | |
|---|---|
| 7. | <attributeGroup ref = ‘mb:IndexDescriptorAttributes’/> |

| | |
|---|---|
| 8. | </extension> |

| | |
|---|---|
| 9. | </simpleContent> |

| | |
|---|---|
| 10. | <complexType> |

| | |
|---|---|
| 11. | </element> |
| 12. | <element name = ‘Photographer’> |

| | |
|---|---|
| 13. | </complexType> |

| | |
|---|---|
| 14. | <simpleContent> |

| | |
|---|---|
| 15. | <extension base = ‘string’> |

| | |
|---|---|
| 16. | <attributeGroup ref = ‘mb:IndexDescriptorAttributes’/> |

| | |
|---|---|
| 17. | </extension> |

| | |
|---|---|
| 18. | </simpleContent> |

| | |
|---|---|
| 19. | </complexType> |

| | |
|---|---|
| 20. | </element> |

| | |
|---|---|
| 21. 22. 23. 24. 25. 26. | 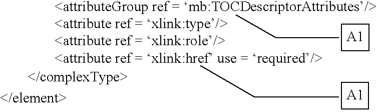 |

### EXAMPLE D:

| | |
|---|---|
| 1. | <VideoClip xlink:href = |
| | ‘http://someSite/content/video/clip999.mpg’> |
| 2. | <Date>2000-04-18</Date> |
| 3. | <Photographer>John Smith</Photographer> |
| 4. | </VideoClip> |

In the preferred arrangement, the core media browser attributes are explicitly expressed in the descriptions, and in schemas. Alternative arrangements can infer these attribute values from other information in descriptions, as described below. For example, a descriptor/element may be treated as part of the TOC if it contained a link within either its attributes or within the attributes of its children. Further, descriptors which do not have descendant links may be treated as index descriptors. Similarly visual identifiers may be automatically constructed from element (descriptor) names.

Clearly there are alternative ways in which the core media browser and xlink semantics can be represented. For example, using XML Schema it is possible to define a core Descriptor type and from that core type derive TOCDescriptor and IndexDescriptor types (see Example E). Then individual schema definitions could extend these base types to provide implementation-based descriptors such as those defined in Example C. Also, the preferred arrangement uses XML Schema as its schema representation languages. Other suitably expressive schema languages could also be used.

### EXAMPLE E:

| | |
|---|---|
| 1. | <simpleType name = ‘DescriptorType’> |
| 2. | <restriction base = ‘string’> |
| 3. | <enumeration value = ‘TOC’/> |
| 4. | <enumeration value = ‘Index’/> |
| 5. | <enumeration value = ‘Other’/> |
| 6. | </restriction> |
| 7. | </simpleType> |
| 8. | <complexType name = ‘Descriptor’> |
| 9. | <attribute name = ‘id’ type = ‘ID’/> |
| 10. | <attribute name = ‘textIdentifier’ type = ‘string’/> |
| 11. | <attribute name = ‘visualIdentifier’ type = ‘anyURI’/> |
| 12. | <attribute name = ‘descriptorType’ type = ‘DescriptorType’/> |
| 13. | <attribute name = ‘value’ type = ‘xsd:anyType’/> |
| 14. | <attribute ref = ‘xlink:href’/> |
| 15. | </complexType> |
| 16. | <complexType name = ‘TOCDescriptor’> |
| 17. | <restriction base = ‘Descriptor’> |
| 18. | <attribute name = ‘id’ type = ‘ID’/> |
| 19. | <attribute name = ‘textIdentifier’ type = ‘string’/> |
| 20. | <attribute name = ‘visualIdentifier’ type = ‘anyURI’/> |
| 21. | <attribute name = ‘descriptorType’ type = DescriptorType’ |
| | fixed = ‘TOC’/> |
| 22. | <attribute name = ‘value’ use = ‘prohibited’/> |
| 23. | <attribute ref = ‘xlink:href’/> |
| 24. | </restriction> |
| 25. | </complexType> |
| 26. | <complexType name = ‘IndexDescriptor’> |
| 27. | <restriction base = ‘Descriptor’> |
| 28. | <attribute name = ‘id’ type = ‘ID’/> |
| 29. | <attribute name = ‘textIdentifier’ type = ‘string’/> |
| 30. | <attribute name = ‘visualIdentifier’ type = ‘anyURI’/> |
| 31. | <attribute name = ‘descriptorType’ type = ‘DescriptorType’ |
| | fixed = ‘Index’/> |
| 32. | <attribute name = ‘value’ type = ‘xsd:anyType’/> |
| 33. | <attribute ref = ‘xlink:href’ use = ‘prohibited’/> |
| 34. | </restriction> |
| 35. | </complexType> |

Interpretation of Metadata

In practice, not all the metadata that a user wishes to visualise using the media browser 101 will be represented in a core format known to the media browser 101 and the XLink attributes described above. On parsing a new description, the media browser 101 first attempts to identify the type of metadata that has been received, examples of which may include Dublin Core, MPEG-7 or DIG35 for images, each of these being known in the art. Typically, this can be achieved by examining either the root element of the description or the namespace declarations. If the media browser 101 identifies a metadata standard, then the media browser 101 uses an XSLT stylesheet to transform the incoming document tree (description) into one that explicitly uses the media browser and XLink attributes. No further processing is required. In other words, it is assumed that the transform results in a description that the media browser can present without further processing.

For all other descriptions a check is performed to attempt to ensure that the preferred media browser attributes are present. In one implementation, this check uses a list of rules for the creation of appropriate media browser attributes for the incoming metadata, if they are absent. The rules are as follows:

(i) An href attribute is assumed to represent the target of a simple link and represented as an xlink:href attribute. If the target value of the link is a URI with an extension of XML or no extension, then a link to another description is assumed (ie. xlink:role is set to ‘description’), otherwise the link is assumed to be a link to the relevant content (ie. xlink:role is set to ‘resource’). The type of the link is assumed to be simple (ie. xlink:type is set to ‘simple’).

(ii) An element is classified as a TOC descriptor if either the descriptor or any of its children contains a link (ie mb:descriptorType is set to ‘TOC’). The link may be represented in the original metadata as element content or an attribute. An element not classified as a TOC descriptor is assumed to be an Index descriptor.

(iii) If a descriptor does not have a visualIdentifier or a textIdentifer then a textIdentifer is created with a value that is obtained either from a name attribute of the descriptor, if it exists, or from the element name. In this regard, the media browser 101 preferably always displays a visualIdentifier if one exists, otherwise the textIdentifer is used.

(iv) If a descriptor contains an attribute having a name that indicates that it may be able to act as a visualIdentifier (e.g., keyFrame, thumbnail, preview, etc) then a visualIdentifier attribute is created using that attribute's value. This rule can be implemented by checking each attribute name against a list of possible visualIdentifier names.

Whilst the above lists only four rules, it will be appreciated that alternate and/or additional rules may be developed to provided for meaningful interpretation of unknown metadata types.

However, the use of an XSLT stylesheet is a desired approach because a priori knowledge of the metadata format enables a stylesheet author to define informed transforms. For example, the value of the visualIdentifier attribute may be taken directly from the value of another attribute. An example of a transform for some arbitrary video metadata that is based on a subset of known extended Dublin Core attributes to a form useable by Media Browser is shown in FIG. 15.

In FIG. 15 the source and transformed descriptions are depicted as XML element node trees with attributes shown in the boxes to the right of the corresponding node. Elements are represented using the oval shapes. So, for example, in the source description 1580, the VideoDocument element 1500 has five attributes 1502, namely DC.Title, DC.Creator, DC.Subject, DC.Type, and href. The notation {att_name} is used to denote the value of the attribute of the corresponding element in the source document with the name att_name. The avptr notation is a method of addressing into audiovisual content using XPointer fragments. For example,

http://../AusWild883.mpg#avptr(time::2:05.00,2:55.20)

refers to the fragment of the audio visual content AusWild883.mpg, where the fragment starts 2 minutes and 5 seconds from the start of the content, and end at 2 minutes and 55.2 seconds.

An XSLT transform 1528 of FIG. 15 is configured with knowledge of the syntax and semantics of a source description 1580 for a video document description 1500 having a number of attributes 1502 (e.g. DC.Title). For example, the shown transform assumes that the value of the DC.Identifier attribute in the set of attributes 1510 of the source Scene elements 1504, 1506, 1508, and the DC.Identifier attribute in the set of attributes 1518 of the Shot elements 1512, 1514, 1516 is just a reference identifier and does not provide additional information. For this reason, the transform uses these references as the values of the mb:id attribute. If these identifiers did carry significance to the user of the metadata then these attributes could have been transformed into index descriptors as, for example, the DC.Description attribute of the Scene element 1544. Note also that in FIG. 15 the transformed description does not maintain the initial frame granularity of the source description. In other words, the normalised description 1530 does not contain Frame description as in source description 1500. This represents a decision made by the designer of the stylesheet 1528 which typically operates with knowledge of the media browser interface 101.

In the example of FIG. 15, it may initially appear counterproductive to transform a description that uses elements to represent structure and attributes to represent properties, into an element tree. However, concepts of what information should be represented as attributes and what information should be represented as elements often vary with media type, as described above. For this reason, transforming source metadata into an element tree is a form of normalising the metadata, and the transform 1528 thus results in a normalised description 1590 able to be processed and presented by the media browser 101.

The source description 1580 is an XML document seen in Appendix 1. The media browser 101 does not attempt to transform any relevant schema, if one exists. Consequently, the transformed description does not conform to a schema and therefore the description cannot be annotated. This is emphasised in the transformed description by setting the updateable attribute of the media browser 101 to false in the root element 1532 of the transformed description 1590. The XSLT stylesheet used to achieve the transform 1528 is seen in Appendix 2.

III. Metadata Servers

A link to a metadata server 212 is represented using a URI. An expression describing the request is appended to a URI that uniquely identifies the metadata server 212. For example, the URI: http://somesite/myMetadata/Svr?<query_string>, has an identifier component which is the part of the URI preceding the question mark symbol and a request component which carries information about the request to be sent to the metadata server 212. The identifier component is itself a URI.

The preferred arrangement interprets the link by first using the identifier part of the URI to locate the metadata server 212 on the network 102. Failure to identify the metadata server 212 results in a failed link and the media browser 101 user can be notified of the failure to detect a running process. In the preferred arrangement, the metadata server 212 must be running as a process and the process being run by the metadata server 212 cannot be initiated from the media browser 101. In alternative arrangements, the media browser 101 may be configured to initiate the one or more metadata server processes.

When an identified metadata server 212 receives a request, the server 212 interprets the request and replies with an XML description that satisfies the request. Preferably the description is sent as hyper text (XML), however the description may be encoded if desired or necessary. The types and elements used in the description are preferably defined in a schema that the media browser 101 can access. Although, the descriptions are not validated against their schema by the media browser 101 in the described arrangement, the media browser 101 prefers to have access to the schema. If a schema is not available then some media browser functions may not be available. Preferably, the types and elements of the schema used by the metadata server 212 are derived using the core attributes defined above in Section II.

The requests directed at the metadata server 212 may be for metadata required for browsing or a search expression. The request can also specify various parameters that control the delivery of the XML back to the requesting media browser service.

The results of requests that are directed at a metadata server 212 are descriptions which are preferably contained in an element, either of the type, or derived from the type MetadataCollection, an example of which is provided below as Example F. The MetadataCollection type provides a means for the metadata server to explicitly return information to the requesting media browser application or service (eg. the number of items that satisfy the request and the number of items that are actually returned in the description).

### EXAMPLE F:

| | |
|---|---|
| 1. | <complexType = ‘MetadataCollection’> |
| 2. | <attribute name = ‘descriptorType’ type = |
| | mb:DescriptorType fixed = ‘Other’/> |
| 3. | <attribute name = ‘requestID’ type = ‘string’/> |
| 4. | <attribute name = ‘noItemsIdentified’ type = ‘integer’/> |
| 5. | <attribute name = ‘noItemsReturned’ type = ‘integer’/> |
| 6. | <attribute name = ‘startItemReturned’ type = ‘integer’/> |
| 7. | </complexType> |

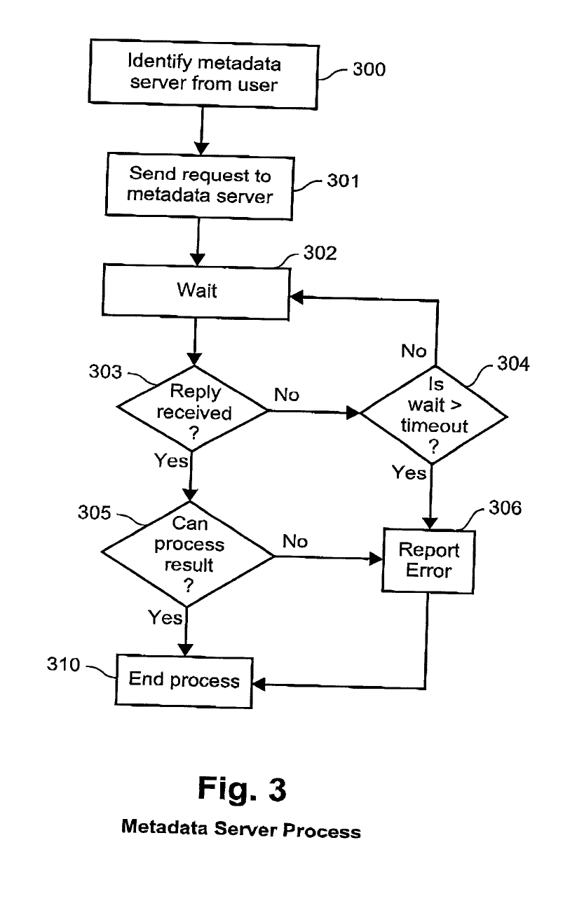

Before details of the request syntax are described, the overall processing model for the communication performed by the media browser 101 with a metadata server 212 is described with reference to the flow chart of FIG. 3. Firstly, in step 300, the metadata server 212 is identified from the URI. The request is then sent to the identified metadata server 212 in step 301. Technically what occurs in the preferred arrangement is that the URI containing the metadata server request is fetched using the HTTP. In other words, steps 300 and 301 are performed as a single process. The system then waits in step 302 for a reply. A check is performed in step 303 to see if a reply has been received. If not, then the waiting period is compared with a predetermined timeout in step 304 and if the waiting period is not greater than the timeout, control passes back to step 302. If the waiting period is greater than the timeout, an error is reported to the media browser user in step 306 and the process terminates in step 310 (ie. the metadata server 212 has not been reached for some reason).

If a reply is received in step 303 the media browser 101 examines the response. If the media browser 101 cannot process the response (eg. the response is not correctly structured) then an error is reported in step 306 and the process terminates in step 310. If the response is able to be processed (ie. parsed) then it is passed to the appropriate module in the media browser 101 for further processing and the process terminates in step 310.

The request syntax will now be discussed in more detail.

Typically most legacy databases store metadata in relational databases and access these databases using Standard Query Language (SQL). On the other hand, XML documents, and hence the media browser 101, represent information (metadata) in an hierarchical fashion. The metadata server 212 request must provide a bridge between the two different representations. Although it may be simpler to implement metadata servers if the request was based on SQL, the media browser 101 uses XML-related technology. In particular, the metadata server request is based on the W3C Recommendation XPath Version 1.0, which may be found at http://www.w3.org/TR/xpath. It may also be possible to use the emerging W3C standard XQuery.

XPath provides an extremely understandable way to describe a class of nodes which are to be processed. It is declarative rather than procedural and uses a simple pattern syntax modelled after directory notation. The most common form of XPath expressions are location paths. A location path selects a set of nodes relative to a context node. A location path can be absolute (starts with a ‘/’ to denote the root node) or relative (to a context node). For example, the expression book/author is a relative location path which selects all author children of book children of the context node. The XPath syntax is most easily understood by way of examples and examples are provided at http://www.w3.org/TR/xpath. A number of XPath examples are as follows:

(i) /* selects all the children of the root node

(ii) /doc/chapter[5]/section[2] selects the second section of the fifth chapter of the doc.

(iii) */para selects all the para grandchildren of the context node

(iv) para[@type=“warning”] selects all the para children of the context node that have a type attribute with the value of warning.

(v) chapter[title=“Introduction”] selects the chapter children of the context node that have one or more title children with string value equal to Introduction.

The location path syntax of XPath is directly useable for representing browsing requests and also for structured queries. In order to package unstructured queries (search expressions) as requests to the metadata server, XPath's function notation is used. This requires a more detailed understanding of XPath.

The primary syntactic construct in XPath is the expression. An expression is evaluated to yield an object which is one of the following four basic types:

Node-set (an unordered collection of nodes without duplicates);

Boolean (true or false);

Number (a floating point value); and

a String.

A location path, as discussed above, is a special case of an XPath expression. A location path returns the set of nodes selected by the path. The part of the location path that is enclosed by square brackets ‘[ ]’ is called the predicate. The predicate is itself an XPath expression which returns a Boolean result which serves to filter the node set selected with respect to the defined axis (tree relationship between the nodes selected and the context node) of the location step.

An expression can also be a function call, which, optionally, takes arguments. The EBNF (Extended Backus Naur form) definition of a function call is taken from Section 3.2 of the above referenced W3C Recommendation found at http://www.w3.org/TR/xpath:

FunctionCall::=FunctionName ‘(‘(Argument(‘,’Argument)*)?’)’

Argument::=Expr

Note the production Expr is the basic construct of XPath. A core function library exists which must be implemented by XPath implementations. Each function in the library is specified using a function prototype which gives the return type, the name of the function and the type of arguments. Although no core functions exist that can be used to pass the request to perform an unstructured query, it is trivial to extend XPath by defining a user function.

Therefore, the syntax for requests is based on XPath with additional functionality to specify parameters that control the transmission of metadata to media browser. The syntax is detailed below using EBNF:

Request::=XPathExpression (‘&’ ParameterList)?

ParameterList::=MaximumItems? (‘&’ StartItem)? (‘&’ NumberLevels)? (‘&’TransactionID)?

MaximumItems::=‘maxItems=’ Number

StartItem::=‘startItem=’Number

NumberLevels::=‘noLevels=’Number

TransactionID::=‘requestID=’Nmtoken

Number::=Digit (Digit)*

The Request contains a single XPathExpression followed by an optional ParameterList. The XPathExpression matches the production LocationPath of the XPath Version 1.0 described at http://www.w3.org/TR/xpath with the exception that the predicate expression must support the following additional function call:

Function:Boolean query(unstructuredQuery)

This function can be included in a location path and be used to request that the metadata server 212 pass the unstructured query on to a search engine associated with the database 210. For example, the location path/Lifestyles/images[query(“surfing”)] would therefore be interpreted by a metadata server 212 as finding all those images that are children of the Lifestyles node that satisfy the unstructured query “surfing”. Note that the expression unstructuredQuery must be encoded appropriately for inclusion in the URI. Appropriate encoding is specified by the Network Working Group's Request for Comments (RFC) 2396 available from http://www.ietf.org/rfc.html.

Both Nmtoken and Digit mentioned above are defined in the XML Version 1.0 Recommendation (see http://www.w3.org/TR/1998/REC-xml-19980210).

The ParameterList component of a Request is optional. ParameterList contains the optional individual productions MaximumItems, StartItem, NumberLevels and TransactionID which specify the maxItems, startItem, noLevels and requestID parameters, respectively. If any of these parameters are not specified then the media browser 101 uses a default value.

The parameter maxItems refers to the maximum number of items to be returned by the metadata server 212. So, for example, if a particular section of a collection contained a large number of items then media browser could request the first, say (n=101) items. The default value is specified by the user within the media browser 101. This parameter is automatically inserted into the Request by the media browser 101. If the user does not specify a value, a system default is used (eg. maxItems=100).

The startItem parameter allows the media browser 101 to get the next n items starting from a specified item number. The startItem parameter is useful in retrieving search results from a metadata server 212. If it is not specified in a URI, then a value of ‘1’ is assumed by the metadata server 212.

The parameter noLevels enables the media browser 101 to define the structure of the returned description. Typically a single (hierarchical) level of description is required, however more levels may be desirable in the event of a user requesting a particular view that contains more than one level of the hierarchy (eg. scenes and clips for a video). If this parameter is not specified then a value of one hierarchical) level is assumed.

The requestID parameter allows a request to be formulated that refers to a previous request. For example, it may be desirable to obtain the next set of items from a previous request. If a requestID is specified then the metadata server 212 will attempt to reply using the previous request that is identified by the requestID. If the request identified by the requestID is no longer available in a cache of the metadata server 212 then the processing associated with the request will have to be repeated. The requestID is a unique value for the metadata server 212 and is generated by the metadata server 212 (and may be based on a timestamp representing the receipt of the request by the metadata server 212). The requestID can be returned to the media browser 101 using an element having the type, or being derived from the type, MetadataCollection (see Example F).

Browsing Requests

In one implementation a default Request, used when initially gaining browsing entry to a metadata collection for the purposes of browsing, may be the XPathExpression, “/*” with any desired parameters formatted in a ParameterList (eg. “/*&maxItems=100&noLevels=2”). The corresponding URI would then be:

http://mySite/myMetadataSvr?/*&maxItems=100&noLevels=2

where //mySite/myMetadataSvr is the URI of the metadata server process.

On receipt of this request, the metadata server 212 invokes a procedure to satisfy the request. This procedure results in the dynamic generation of an XML description of the associated metadata collection. This description thus reflects a structure by which the associated metadata collection may be browsed. It is common for the metadata collection to be stored in a database of some form. For example, the metadata server 212 may be configured to provide category or publisher sections for the collection so that users can more readily browse the metadata. Typically these categories are reflected in the schema used to describe the database items. Alternatively, the metadata server 212 may reply to the request from the media browser 101 by simply sending a list of all the separate items in the database.

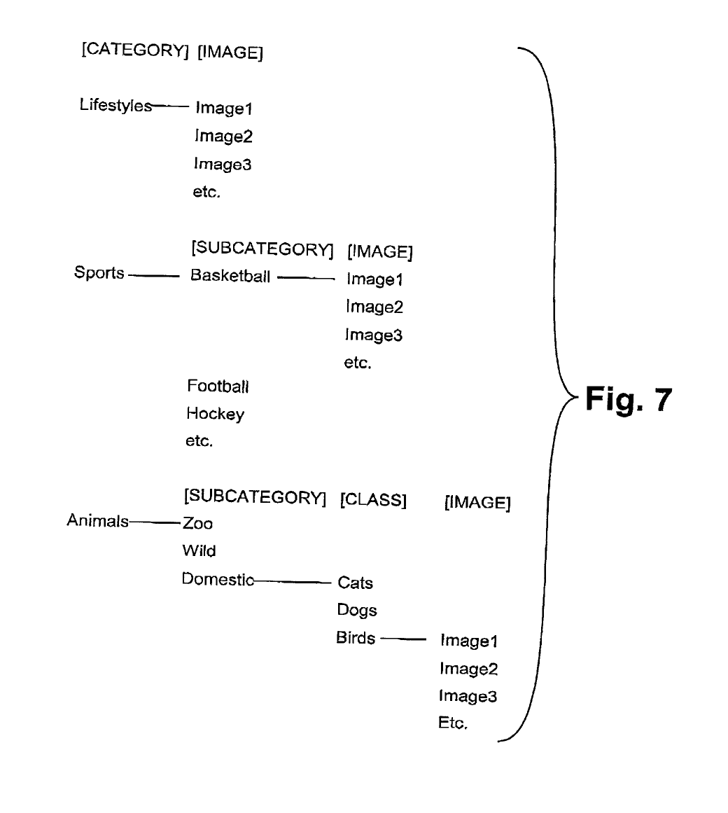

For the purpose of describing a typical scenario of use, consider an image metadata database with the following structure. The database is composed of a number of categories including Lifestyles, Sports and Animals as illustrated in FIG. 7. Whereas the Lifestyles category has no further structure (ie. it is composed of solely images), the Sports category is structured further into subcategories and the Animals category is structured further into subcategories and then image classes. It is not important how this data is actually stored for the purposes of the present description.

There is no fixed way that a metadata server 212 may implement its translation facility for its metadata collection. One possible way is described below.

The metadata server 212 generates descriptions based on an XML schema definitions of types for Categories, Subcategories, Classes and Images. Typically these schema definitions reside in a single XML Schema document. Preferably these definitions use the core attributes of the media browser 101 and the global XLink attributes (see Section II above). A basic example of such definitions is provided below in Example G of an XML Schema. Note, that the definitions can use the xlink:show attribute to direct the media browser 101 to “embed” the target of the link at the source (ie. the description fragment generated by the metadata server 212 would be simply included as the content of the link source element). Definitions may also set this attribute value to “replace”, in which case the media browser 101 would replace the descriptor, which is the link source, with the description fragment served by the metadata server 212.

### EXAMPLE G

### XML Schema Example

| | |
|---|---|
| 1. | <?xml version = ‘1.0’?> |
| 2. | <schema |
| 3. | xmlns = ‘http://www.w3.org/1999/XMLSchema’ |
| 4. | xmlns:mb = ‘http://www.cisra.com.au/MediaBrowser’ |
| 5. | xmlns:xlink = ‘http://www.w3.org/1999/xlink’ |
| 6. | xmlns:image = ‘http://www.somesite/ImageLibrary’ |
| 7. | targetNamespace = ‘http://www.somesite/ImageLibrary’ |
| 8. | version = ‘1.0’> |
| 9. | <element name = ‘ImageLibrary’> |
| 10. | <complexType> |
| 11. | <complexContent> |
| 12. | <extension base = ‘mb:MetadataCollection’> |
| 13. | <choice> |
| 14. | <element ref = ‘im:Category’ minOccurs = ‘0’ |
| | maxOccurs = ‘unbounded’/> |
| 15. | <element ref = ‘im:SubCategory’ minOccurs = ‘0’ |
| | maxOccurs = ‘unbounded’/> |
| 16. | <element ref = ‘im:Class’ minOccurs = ‘0’ |
| | maxOccurs = ‘unbounded’/> |
| 17. | <element ref = ‘im:Image’ minOccurs = ‘0’ |
| | maxOccurs = ‘unbounded’/> |
| 18. | </choice> |
| 19. | </extension> |
| 20. | </complexContent> |
| 21. | </complexType> |
| 22. | </element> |
| 23. | <element name = ‘Category’> |
| 24. | <complexType> |
| 25. | <choice> |
| 26. | <element ref = ‘im:SubCatgeory’/> |
| 27. | <element ref = ‘im:Image’/> |
| 28. | </choice> |
| 29. | <attributeGroup ref = ‘mb:TOCDescriptorAttributes’/> |
| 30. | <attribute ref = ‘xlink:type’/> |
| 31. | <attribute ref = ‘xlink:href’/> |
| 32. | <attribute ref = ‘xlink:role’/> |
| 33. | <attribute ref = ‘xlink:show’/> |
| 34. | </complexType> |
| 35. | </element> |
| 36. | <element name = ‘SubCategory’> |
| 37. | <complexType> |
| 38. | <choice> |
| 39. | <element ref = ‘im:Class’/> |
| 40. | <element ref = ‘im:Image’/> |
| 41. | </choice> |
| 42. | <attributeGroup ref = ‘mb:TOCDescriptorAttributes’/> |
| 43. | <attribute ref = ‘xlink:type’/> |
| 44. | <attribute ref = ‘xlink:href’/> |
| 45. | <attribute ref = ‘xlink:role’/> |
| 46. | <attribute ref = ‘xlink:show’/> |
| 47. | </complexType> |
| 49. | </element> |
| 50. | <element name = ‘Class’> |
| 51. | <complexType> |
| 52. | <element ref = ‘im:Image’/> |
| 53. | <attributeGroup ref = ‘mb:TOCDescriptorAttributes’/> |
| 54. | <attribute ref = ‘xlink:type’/> |
| 55. | <attribute ref = ‘xlink:href’/> |
| 56. | <attribute ref = ‘xlink:role’/> |
| 57. | <attribute ref = ‘xlinkshow’/> |
| 58. | </complexType> |
| 59. | </element> |
| 60. | element name = ‘Image’> |
| 61. | <complexType> |
| 62. | <sequence> |
| 63. | <element ref = ‘im:ImageID’/> |
| 64. | <element ref = ‘im:Name’/> |
| 65. | <element ref = ‘im:Caption’/> |
| 66. | <element ref = ‘im:Photographer’/> |
| 67. | <element ref = ‘im:Keywords’/> |
| 68. | </sequence> |
| 69. | <attributeGroup ref = ‘mb:TOCDescriptorAttributes’/> |
| 70. | <attribute ref = ‘xlink:type’/> |
| 71. | <attribute ref = ‘xlink:href’/> |
| 72. | <attribute ref = ‘xlink:role’/> |
| 73. | <attribute ref = ‘xlink:show’/> |
| 74. | </complexType> |
| 75. | </element> |
| 76. | <element name = ‘Name’> |
| 77. | <complexType> |
| 78. | <simpleContent> |
| 79. | <extension base = ‘string’> |
| 80. | <attributeGroup ref = ‘mb:IndexDescriptorAttributes’/> |
| 81. | </extension> |
| 82. | </simpleContent> |
| 83. | </complexType> |
| 84. | </element> |
| 85. | <element name = ‘Photographer’> |
| 86. | <complexType> |
| 87. | <simpleContent> |
| 88. | <extension base = ‘string’> |
| 89. | <attributeGroup ref = ‘mb:IndexDescriptorAttributes’/> |
| 90. | </extension> |
| 91. | </simpleContent> |
| 92. | </complexType> |
| 93. | </element> |
| 94. | <element name = ‘ImageID’> |
| 95. | <complexType> |
| 96. | simpleContent> |
| 97. | <extension base = ‘string’> |
| 98. | <attributeGroup ref = ‘mb:IndexDescriptorAttributes’/> |
| 99. | </extension> |
| 100. | </simpleContent> |
| 101. | </complexType> |
| 102. | </element> |
| 103. | <element name = ‘Caption’> |
| 104. | <complexType> |
| 105. | <simpleContent> |
| 106. | <extension base = ‘string’> |
| 107. | <attributeGroup ref = ‘mb:IndexDescriptorAttributes’/> |
| 108. | </extension> |
| 109. | </simpleContent> |
| 110. | </complexType> |
| 111. | </element> |
| 112. | <element name = ‘Keywords’> |
| 113. | <complexType> |
| 114. | <simpleContent> |
| 115. | <extension base = ‘string’> |
| 116 | <attributeGroup ref = ‘mb:IndexDescriptorAttributes’/> |
| 117. | </extension> |
| 118. | </simpleContent> |
| 119. | </complexType> |
| 120. | </element> |
| 121. | </schema> |

The schema document in Example G contains a declaration for root element, ImageLibrary, that extends the MetadataCollection type defined for the media browser (mb) namespace (see Example F). It thus inherits all the attributes defined for the base type (i.e., descriptorType, requestID, noItemsIdentified, noItemsReturned, startItemReturned). In addition it is defined to contain any of the following list of descriptors: Category, SubCategory, Class or Image. What is actually returned by the metadata server as the content of this root element will depend on the request received.

The schema document also contains declarations for the following TOC descriptors: Category, SubCategory, Class and Image. Each of these descriptors is defined to contain the attribute group TOCDescriptorAttributes (from the mb namespace and defined in Example A) and a set of linking attributes (type, href, role and show from the xlink namespace).

In this example, the type, show and role attributes will default to “simple”, “new” and “resource”, respectively, unless overwritten in an instance (e.g., the XML document generated by the metadata server in response to a request). So, for example, the default value of the xlink:show attribute will need to be over written if a link to another metadata server request is to be included. In this case, usually the desired value for this attribute is “embed” which instructs the receiver of the generated description to embed the element content description as a child element of the descriptor containing the link source to the metadata server. It is also possible to set the value of the xlink:show attribute to be “replace” which means that the element content of the generated description should replace the descriptor containing the original link to the metadata server. The default value for the xlink:show attribute can be used if a link to a resource is the objective. In this case you want the resource to be displayed in a new window (hence the use of the word “new” for the default value).

Also the generated description will need to overwrite the value of the xlink:role attribute if the objective of link is to link to a further description. In this case the value of this attribute should be set to “description ”.

Each of the declared descriptors in Example G inherit a visualIdentifier attribute (from either the TOCDescriptorAttributes or IndexDescriptorAttributes group). This attribute is used by the media browser 101 to provide a visual representation of the content of the item. For example, if the item is an image then the visualIdentifier attribute value will typically contain the URI of a thumbnail of the image. In the case of categories, subcategories and classes the visualIdentifier attribute value can contain the URI of an icon. If this attribute is not specified then, preferably, the media browser 101 generates the visual identifier for the item from a provided textIdentifier attribute value, or, in the event that this value is also not provided, from the name of the element (in this case Image, Class, Subcategory or Category).

On receipt of the “/*” Request, the metadata server 212 generates an XML description of the collection as in the XML fragment below of Example H. The description is contained in an element declared to be of type MetadataCollection (see Example G) and it contains returning links to the metadata server for further descriptions. Note that the metadata server needs only specify the XPathExpression in its returning links. It is the responsibility of the media browser to add the ParameterList to the URI before despatching the request.

### EXAMPLE H

### Returned XML Description Fragment

| | |
|---|---|
| 1. | <ImageLibrary |
| 2. | requestID = ‘19999123’ |
| 3. | noItemsIdentified = ‘3’ |
| 4. | startItemReturned = ‘1’ |
| 5. | noItemsReturned = ‘3’> |
| 6. | <Category |
| 7. | textIdentifier = ‘Lifestyles’ |
| 8. | xlink:href = |
| | ”http://mySite/myMetadataSvr?Category[@textIdentifier = |
| | ‘Lifestyles’]/Image” |
| 9. | xlink:role = ‘description’ |
| 10. | xlink:show = ‘embed’ |
| 11. | visualIdentifier = ‘http://mySite/Metadata/icons/Lifestyles.gif’/> |
| 12. | <Category |
| 13. | textIdentifier = ‘Sports’ |
| 14. | xlink:href = |
| | “http://mySite/myMetadataSvr?Category[@textIdentifier = |
| | ‘Sports’]/Subcategory” |
| 15. | xlink:role = ‘description’ |
| 16. | xlink:show = ‘embed’ |
| 17. | visualIdentifier = ‘http://mySite/Metadata/icons/Sports.gif’/> |
| 18. | <Category |
| 19. | textIdentifier = ‘Animals’ |
| 20. | xlink:href = |
| | “http://mySite/myMetadataSvr?Category[@textIdentifier = |
| | ‘Animals’]/Subcategory” |
| 21. | xlink:role = ‘description’ |
| 22. | xlink:show = ‘embed’ |
| 23. | visualIdentifier = ‘http://mySite/Metadata/icons/Animals.gif’/> |
| 24. | </ImageLibrary> |

In the Example H above description, XPathExpressions in the return links to the metadata server are used to identify links to each of the images in the Lifestyles category and the subcategories in the Sports and Animals categories. These links would be activated when a user selected to expand one of the above items when they were visually presented in media browser 101. In the preceding and following examples, the XPathExpressions have been specified as relative location paths assuming that the context node is the root node of the collection. Alternatively, absolute paths can be used.

In Example H above the URI targets of the return links to the metadata server contains the ‘[‘and’]’ characters. In general, according to RFC 2396, it is unwise to leave these characters unencoded in a URI because they can be excluded by some gateways and transport agents. The characters have been left unencoded in this and following Examples for ease of reading.

If, for example, the visual identifier for the ‘Sports’ category was selected when the XML fragment shown in Example H was processed and presented to the user, then the corresponding returning link to the metadata server would be actuated. The metadata server 212 would respond to this link by generating and returning a description fragment as now indicated below in Example I.

### EXAMPLE I

### Returned XML Description Fragment

| | |
|---|---|
| 1. | <ImageLibrary |
| 2. | requestID = ‘19999124’ |
| 3. | noItemsIdentified = ‘1200’ |
| 4. | startItemReturned = ‘1’ |
| 5. | noItemsReturned = ‘100’> |
| 6. | <Subcategory |
| 7. | textIdentifier = ‘Basketball’ |
| 8. | xlink:href = |
| | ”http://mySite/myMetadataSvr?Category[@textIdentifier = |
| | ‘Sports’]/Subcategory[@textIdentifier = ‘Basketball’]/Image” |
| 9. | xlink:role = ‘description’ |
| 10. | xlink:show = ‘embed’/> |
| 11. | <Subcategory |
| 12. | textIdentifier = ‘Football’ |
| 13. | xlink:href = |
| | “http://mySite/myMetadataSvr?Category[@textIdentifier = |
| | ‘Sports’]/Subcategory[@textIdentifier = ‘Football’]/Image” |
| 14. | xlink:role = ‘description’ |
| 15. | xlink:show = ‘embed’/> |
| 16. | <Subcategory |
| 17. | textIdentifier = ‘Hockey |
| 18. | xlink:href = |
| | “http://mySite/myMetadataSvr?Category[@textIdentifier = |
| | ‘Sports’]/Subcategory[@textIdentifier = ‘Hockey’]/Image” |
| 20. | xlink:role = ‘description’ |
| 21. | xlink:show = ‘embed’/> |
| 22. | </ImageLibrary> |

It is preferred that the returned description be well-formed. Further, the returned description must be able to be parsed by the media browser 101. The media browser's action on receiving the contents of a link depend on the xlink attribute show as described previously. Typically, this attribute will be set to “embed” in which case the received description is embedded at the source of the link. If the received description used a container element (eg. of type MetadataCollection as defined in Example F) then this element is also embedded. Preferably embedded container elements are defined as having a descriptorType value of “Other” (see Example A). Alternatively as previously mentioned, the xlink:show attribute can be set to “replace” in which case the contents of the link will replace the element containing the link source. If the xlink:show attribute is not included for the linking element in the description generated by the metadata server then the default action is “new”. This means that the contents of the link are displayed in a new window. Clearly this is behaviour that is desirable for content (i.e., a resource) rather than for a description.

The description of the collection may be further explored by a user selecting one of these subcategories. This action would result in the metadata server 212 generating a description of the images contained in the selected subcategory.

Note that the description of Example I, which is dynamically generated by the metadata server 212, contains only a single hierarchical level. This can be altered by specifying the noLevels parameter in the ParameterList of the URI. In some cases a Request might require two levels of hierarchical description in order to generate a view that requires both the parent and the children TOC elements. For example, if the media browser 101 was using a two-level view and wished to retrieve descriptions that contained two levels of TOC hierarchy, then the media browser 101 would append the “noLevels=2” parameter to the URI. For example, the link:

http://mySite/myMetadataSvr?Category/Subcategory[Category
/@textIdentifler=‘Sports’]&noLevels=2

would result in the description fragment shown below in Example J.

The second level is assumed to be the TOC children of the level targeted by the link. Preferably when the value of noLevels is greater than one, the values of the parameters, maxItems and startItem should refer to the lowest TOC level of the description. Similarly, the values of any returned parameters also refer to the lowest level of the description. Note also that the Index Descriptor children of the lowest TOC level can also be included in the returned XML as shown below an Example J.

### EXAMPLE J

### Returned XML Description Fragment

| | |
|---|---|
| 1. | <ImageLibrary |
| 2. | requestID = ‘19999125’ |
| 3. | noItemsIdentified = ‘500’ |
| 4. | startItemReturned = ‘1’ |
| 5. | noItemsReturned = ‘100’> |
| 6. | <Subcategory |
| 7. | textIdentifier = ‘Basketball’ |
| 8. | xlink:href = |
| | “http://mySite/myMetadataSvr?Category[@textIdentifier = |
| | ‘Sports’]/Subcategory[@textIdentifier = |
| | ‘Basketball’]/Image” |
| 9. | xlink:role = ‘description’ |
| 10. | xlink:show = ‘embed’> |
| 11. | </Image |
| 12. | textIdentifier = ‘Image1’ |
| 13. | xlink:href = “http://mySite/images/image1.jpg’> |
| 14. | <ImageID>Image001 </ImageID> |
| 15. | Etc. |
| 16. | </Image |
| 17. | textIdentifier = ‘Image2’ |
| 18. | xlink:href = “http://mySite/images/image2.jpg’> |
| 19. | <ImageID> Image002 </ImageID> |
| 20. | Etc. |
| m. | </Subcategory> |
| m+1. | <Subcategory |
| m+2. | textIdentifier = ‘Football’ |
| m+3. | xlink:href = |
| | “http://mySite/myMetadataSvr?Category[@textIdentifier = |
| | ‘Sports’]/Subcategory[@textIdentifier = |
| | ‘Football’]/Image” |
| m+4. | xlink:role = ‘description’ |
| m+5. | xlink:show = ‘embed’> |
| m+x | Etc. |
| n. | </Subcategory> |
| n+1. | </ImageLibrary> |

Searching Requests

Searching requests can originate from either the user specifying a structured query, using an advanced search option, or the user specifying an unstructured query, using the simple search option. The term structured query is used herein to mean a query that is composed of a set of constraints which are expressed in terms of known properties of the information source. These constraints can be combined in a conjunctive (and) or disjunctive (or) manner or a mixture of the two. The term unstructured query is used herein to mean a query which comprises a list of keywords and expressions, with or without conjunctions (e.g., the type of query used by most search engines such as Yahoo!®, AltaVista®, etc). The major difference between the two query types is that a structured query is formulated with a knowledge of the information source (e.g., the metadata database's schema).

If a structured query is formed then this query is preferably represented using an XPathExpression, with constraints being represented as predicates for location steps, as described for browsing in the previous section. Therefore only unstructured queries need to be considered in this section.

Most metadata collections presently in existence have an unstructured search function. In many cases considerable effort has been expended to make this search function as optimal, in terms of speed and suitable results, as possible. Consequently it is advantageous to use these search facilities whenever an unstructured query is specified by a user.

Unstructured queries can be passed to the metadata server 212 using the query function call defined earlier in this section. This function call is preferably included within a predicate of a step of a location path. As location paths can contain a predicate for each of their location steps, an XPathExpression can contain more than one unstructured query expressions. However, most requests based on unstructured queries contain a single query expression. For example, the XPathExpression, //image[query(“dog OR cat”)], will select all the image items of the root node that satisfy the query “dog OR cat”. Note that the XPathExpression would need to be appropriately encoded before being dispatched as part of a URI (see RFC 2396). For example, space characters should be encoded using the character triplet %20.

Typically searches can result in a large number of items. The description that is returned to the media browser 101 can be limited in the number of items the description contains by using the maxItems parameter. After receiving the first set of results, the media browser 101 may then request a further set by using the startItem parameter. To do this, the media browser 101 includes the requestID that was returned by the metadata server 212 with the response to the original request. In other words, the returned requestID identifies the start of a transaction that can be accessed by later requests.

The above has a number of implications for the configuration of the metadata server 212 as such requires the metadata server 212 to be able to save and access the results of previous requests. However, traditional server arrangements cannot maintain such results of requests in a cache indefinitely. Preferably, if a request arrives referring to a previous request, the metadata server 212 attempts to match the requestID to its cached request results. If the request is no longer in the cache, it is reprocessed. In an alternative arrangement, if a match cannot be achieved, then the metadata server 212 can optionally attempt to match the request on a textual similarity basis with other requests before resorting to reprocessing the request. This approach is helpful in that it can eliminate much duplicated processing by the metadata server 212. The size of the cache for a metadata server 212 can therefore be implementation dependent.

IV. The Media Browser Application

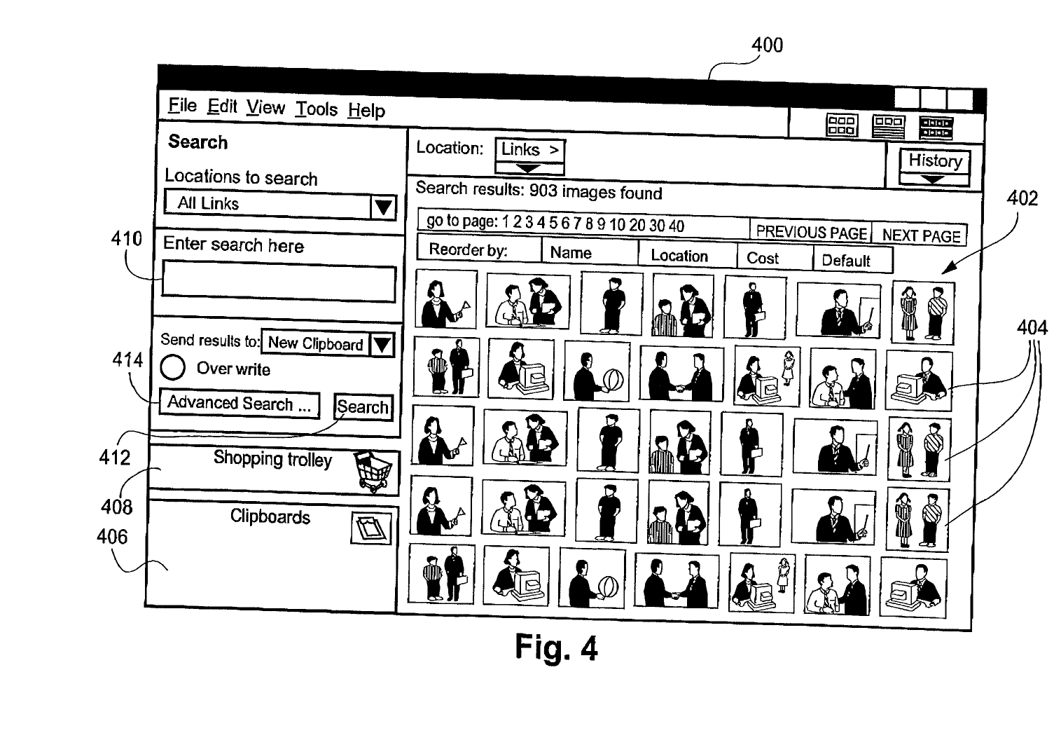

The media browser 101 provides the user with a single user interface for browsing and searching different metadata collections. An example graphical user interface 400 for the media browser 101 is shown in FIG. 4. The media browser interface 400 provides the user with the options of either browsing or searching for (particular items of) content via metadata associated with the (items of) content. The media browser 101 can be implemented as a stand-alone application (eg. like Word97 manufactured by Microsoft Corporation of the USA) or as a service able to be supplied to multiple concurrent users. The preferred arrangement implements the media browser 101 as a service. In this mode each user is required to log in to the service to access their personalised TOC. The service aspect of the media browser 101 is discussed further in Section V below. The present section is devoted to describing the functionality of the media browser 101. The description assumes a media browser service however it should be evident that the functionality could equally well be implemented as a stand-alone program.

Typically the media browser 101 is implemented with a set of default media tool plug-ins. A user of the media browser 101 can then select, and preferably download via the Internet, further media tools to plug-in to their own implementation. Each plug-in has a defined set of target media types. The separation of media playing/viewing from metadata browsing and searching is an important concept for the media browser 101 as such allows the application to be adapted to particular users/environments.

The media browser 101 enables browsing access to the metadata by providing a Table of Contents (TOC) which represents the structure of the information landscape a user chooses to access. This information landscape can comprise links to local metadata and/or links to remote metadata and is typically customised by each user as the user discovers metadata sites which are relevant to personal interests. A default TOC is preferably provided for each new user.

The underlying information landscape is represented at all levels as a description (ie an XML document). This means that the base structure of the description, which for XML is a tree containing nodes and links, is the same whether the user is viewing the entry point of the TOC or viewing the details of a description of a multimedia item of content (eg. a digital video). Since the TOC is a visual representation of the information landscape, the user's navigation in the TOC is unchanged for all levels of the TOC. This means that the interface 400 operates the same whether a user is browsing metadata at different Web sites, different sections of a metadata collection (eg. categories in an image metadata collection), or within a description of multimedia content (eg. a clip in the digital video tape).

The TOC is formed by items that are selectable. These items comprise the visual representations of TOC descriptors (see Section II for more details on metadata representation). The items contain visual identifiers to aid the user in browsing. Typically, the visual identifier represents the content in some way. This is especially true for visual identifiers that correspond to items of multimedia content. Examples of visual identifiers include, simple or graphically-designed text, thumbnails of images, animations, and short previews of videos. Preferably, these visual identifiers are provided by the descriptions but, if not, the media browser 101 can graphically generate them from information contained in the description (eg. textIdentifier attribute or element name). Visual identifiers have been discussed in more detail in Sections II and III.

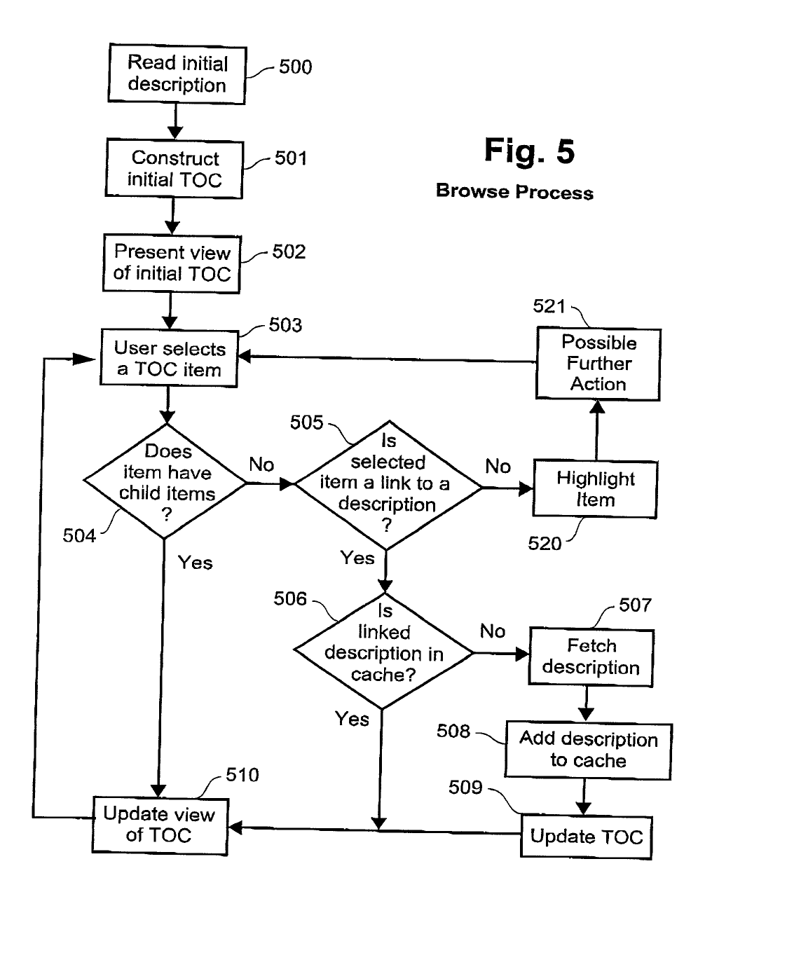

The browsing functionality provided in the preferred arrangement may now be described with reference to FIG. 5. On activating the media browser 101, the initial description of the information landscape is read in step 500. This initial description usually contains a set of top-level links to different metadata collections or sections of metadata collections. The media browser 101 then, in step 501, processes this description and constructs an initial TOC from the description. Typically the processing of a description involves parsing the XML document that contains the description and representing the description using an object model in the computer memory. Preferably, step 501 involves detecting all the TOC descriptors from the description and building a TOC from those descriptors. Preferably, the differentiation between TOC and index descriptors is performed using the core descriptorType attribute as described in Section II.

In step 502 which follows, a view of the initial TOC is generated and presented to the user. This view may be provided in the form of a tree structure as used by applications such as WINDOWS EXPLORER manufactured by Microsoft Corporation. Preferably, a rectangular panel 402 is provided as seen in FIG. 4 showing the visual identifiers 404 that correspond to the items and the initial level of the information landscape. For example, this could be a grid of visual identifiers identifying a number of initial metadata collections.

The media browser 101 then awaits a user event. When a user selects an item, for example by clicking on a visual identifier 404 in step 503, the item is examined in step 504 to determine whether the item has child items in the TOC. This will be the case if a link has been previously followed by the user or an individual description contains more than one level of structure (eg. a description of a collection may often contain several TOC levels in one description). If the item has child items, then control proceeds to step 510 and the view of the TOC is updated with the child items.

If the selected item has no child items in the TOC, then in the step 505, the media browser 101 determines whether the item contains a link to a description. This can be achieved explicitly if the linking element, that represents the source of the link, has a specified role of “description” (roles of linking elements are described earlier). If the role of the link is undefined, then the media browser 101 decides whether the target is a further description based on the file extension of the URI of the link target. For example, if the extension is “.xml”, then a description will be initially assumed. However, if on parsing the “.xml” file, the file is found not to conform to a specified description scheme, then the media browser 101 preferably treats the “.xml” file as a resource rather than a description.

In the event that the selected item does contain a link to a further description, step 506 is implemented where the media browser 101 determines whether the specified description is available in the description cache (ie. the description has previously been fetched, perhaps for another user or a previous session with the present user). If the description is not available, then the media browser 101 fetches that description in step 507. This can be achieved by forwarding an HTTP get request to a standard web server. The returned description is processed and stored in the description cache in step 508. In step 509, the TOC is then updated to reflect the new description using the same principles that were used in creating the initial TOC. Finally the view of the TOC is also updated in step 510 and presented to the user for further interaction. After step 510, control returns to step 503 where a further selection from the TOC may be made.

The browsing event described in the previous paragraphs results preferably in the viewing panel being updated to contain the items at the new level of the information landscape. For example, this new level may show the major categories of a particular metadata collection.

In the event that, at step 505, the selected item did not contain a link to a further description, the link is treated as a link to an item of content. The visual identifier of the item is highlighted in step 520 and further actions can occur in step 521. For example, the identifier could be selected with a number of other items to be dragged to a clipboard 406 or a shopping trolley 408 forming part of the interface 400. If a link to an item of content is double clicked by the user then the item is immediately presented or played using the default media tool for the content type of the selected item.

A preferred implementation of the media browser 101 allows two types of searches. A simple search is constructed by the user providing a text query to a search entry box 410 and selecting a simple search function 412. The user is also able to construct an advanced structured query using a list of the available index descriptors by selecting an advanced search 414. The latter option is possible because the media browser 101 has knowledge of the schemas used for the different descriptions. Preferably, the media browser 101 can construct a list of the index descriptors which are relevant to one or more selected descriptors and the user can specify constraints for the query by entering required values for selected index descriptors. Preferably the constraints thus entered by a user are joined conjunctively (in an “AND” fashion), however clearly other alternatives (disjunctive combination or some mixture of the two) are also possible. The user should also be able to specify the type of constraint (e.g., equal to, less than, greater than, contains, not equal to). For example, if a user would like to search an image database for images that are published by Publisher “ABC” and have a cost in the range $100 to $200, a query is more likely to be successful if the user can build a structured query directly from the descriptors available rather than just use keywords in a textual query. The latter approach, which corresponds to the simple search function mentioned above, could result in the strings “ABC”, “$100” and “$200” being located anywhere in image descriptions. The processing of structured search queries is discussed further below.

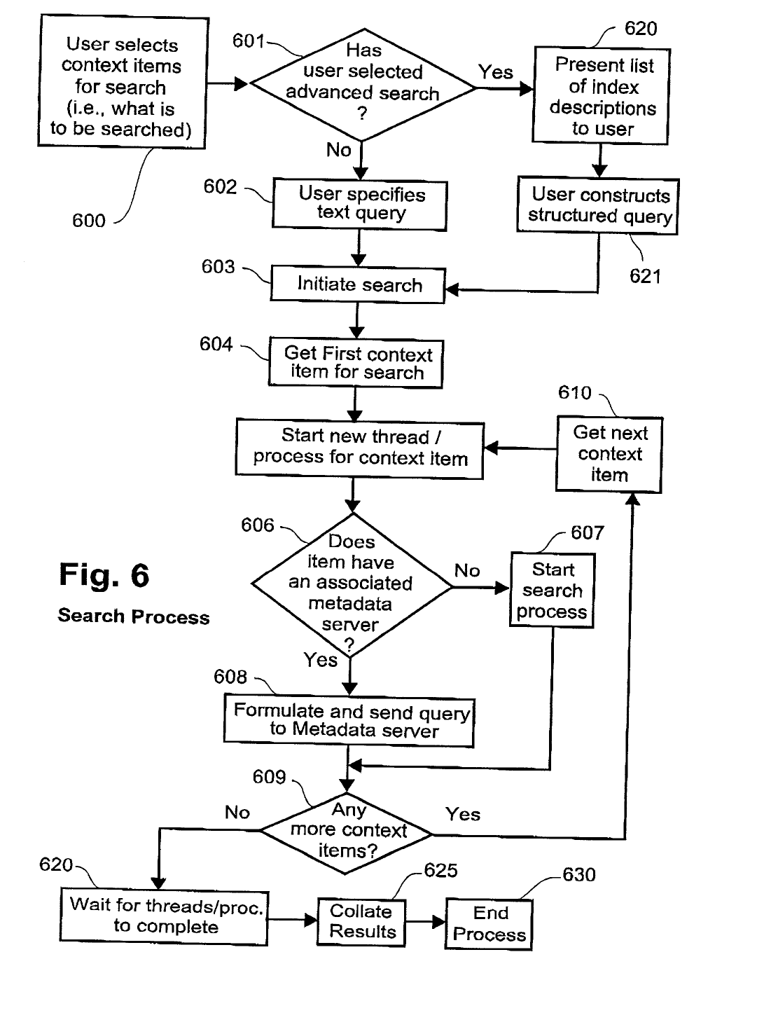

The searching functionality of the preferred arrangement of media browser is described now with reference to FIG. 6. In a first step 600, the user specifies one or more context items for the search. These are items in the TOC that are to be searched when the search is initiated in step 603. Step 601 determines if the user selects an advanced search. If the user does not select to perform an advanced search, control passes to step 602 where the user is required to specify a text query as mentioned above. This query may be formed of a list of keywords or phrases that the user is interested in.

If the user selects to perform an advanced search then control passes from step 601 to step 620. A list of available index descriptors is then generated from schemas definitions and declarations that are relevant to any of the descriptions contained in the list of context items. In a preferred implementation, index descriptors are distinguished from TOC descriptors by the descriptorType attribute as discussed in Section II above. The user in step 621 can then formulate a structured query based on the list of available descriptors and a set of basic search conjunctive operators (eg. AND, OR, and NOT). The user can also express acceptable ranges on particular index descriptors (e.g., the price of an item must be >$100 and <$200) and indicate the type of constraint (e.g., equals or contains).

In step 603 the user initiates the search with the current query (textual or structured). This is followed by step 604 where the first item in the list of context items is identified. A new thread or process is created and then started for the context item in step 605. In step 606, which follows, a check is made to see whether the identified context item has an associated metadata server. If the context item is the origin or root for a particular metadata collection, step 606 involves checking the link in the description. If the identified context item is not an origin or root item, then it is necessary to examine the TOC to establish whether a metadata server exists for a parent of the identified item. If such a check results in the location of a relevant metadata server for the identified item, then the context of the identified item within the metadata collection is included in the location path of the XPathExpression which carries the query as a request to the metadata server. For example, if a selected context item for a search was “Lifestyle category ” in “Image Collection ABC” then the search request would be passed to the metadata server in a URI such as:

http://www.ImagesABC.com/MetadataSvr?/Category[textIdentifier=
‘Lifestyles’]/Image[query<expression>]

where <expression> contains the unstructured query.

If an associated metadata server is identified in step 606 then the query is formulated as a URI (using the request syntax described in Section III) and sent to the identified metadata server in step 608.

If no metadata server is identified then in step 606, a search is commenced for items satisfying the request in the identified context item in step 604 and then control passes to step 609 where any further context items are detected. If further items exist then, in step 610, the next item in the list of context items is identified, and control returns to step 605. If step 609 finds no more context items remain to be identified, then control passes to step 620 where the search process waits for search results to arrive. It will be appreciated in this regard that numerous search processes on individual context items may operate and return results substantially simultaneously. When all threads, or processes, complete, the results of the individual search processes are collated in step 625 and the process ends in step 630.

In the preferred implementation, the user's query (structured or unstructured) is passed unchanged to each of the selected contexts. In an alternative implementation the effective query forwarded to each of the contexts could be modified by the system to take into account the capabilities of the context.

Users can use the browsing and searching functionality of the media browser 101 to locate multimedia content that is of interest. Users can build up temporary collections of items by dragging the visual identifiers of items onto clipboards 406 as shown in FIG. 4. The clipboards 406 can be optionally saved and recalled in a later session. Clipboards 406 are treated like any other level of the information landscape in that they can be viewed in the viewing window and can be selected as a context item for a search. Clipboards 406 can also be inserted in the information landscape under a “Clipboards” heading on the entry TOC. Users can save the contents of clipboards 406 and then retrieve and use the saved clipboards 406 at later sessions.

If content is desired immediately and is available for on-line purchase, then the user can drag the item to the shopping trolley 408. The shopping trolley 408 is effectively a specialised clipboard. Alternative interfaces could simply represent the shopping trolley 408 as such. At any time the user can right-click on the shopping trolley to initiate a “purchase” plug-in media tool. Alternatively, the user might move the mouse over the trolley icon to display a menu of available media tool from which the user can make a selection.

The “purchase” plug-in operates in the same fashion as the media tools, already described, which provide media viewing and playing capability. The user can then select an appropriate “purchase” tool for their implementation. The purchase tool simply examines each of the items in the shopping trolley 408, establishes whether those items can be purchased on-line and, if so, redirects the user to the content provider/distributor's site to purchase the item. In an alternative configuration, users can establish accounts with a media browser service and to purchase items through these accounts. Media browser services are discussed further in Section V.

V. Media Browser Business System

The media browser 101 described in Section IV can be implemented as a service. In a preferred implementation, the media browser 101 is technically implemented as a client —server application and operated as a service to which users can login from the Internet. Each user is preferably securely identified by a password and can store up to a specified limit of data with the service. This user data is composed of an initial TOC description, user preferences, stored clipboards and other information required for client operation (eg. user preferences, information about locally installed plugins, etc.). Preferably this service is provided to the user for a periodic (eg. monthly) subscription fee.

One of the main technical advantages of operating the media browser 101 as a service as described above is that descriptions can be cached. As such, for example, if company “ABC” installed a media browser service, and a large number of the users at company “ABC” used a particular metadata collection, the descriptions from this collection would be available in the description cache of the service. In other words, the descriptions would not need to be fetched for each individual user. This represents a key advantage.

In the preferred implementation, the media browser service operates as a service linked to a standard web server. The media browser client can thus be implemented using a standard Web browser. This means that users can simply go to the media browser home page to start the client on the user's own computer workstation. The server typically operates continuously just as a standard web server does in most web sites.

In the preferred implementation model, a default media browser server is operated from the site of a primary service provider (eg. the company which owns the right to the intellectual property of the technology). Other parties can purchase the rights to install their own media browser service on their own intranet. Such an option may be desirable for parties wanting to optimise the speed of the service for users of their intranet.

A further advantage of the above disclosure lies in a business system centered around the concept of the metadata server 212. As described in Section III, the metadata server 212 provides a means by which a content provider/distributor can make available the metadata stored in a legacy system, such as an SQL database. Therefore, the ability of a content provider/distributor to have a metadata server 212 serving their metadata collection effectively opens their customer base as potential customers now can access their metadata from potentially many sites. Indeed each media browser client can potentially provide access to the content provider/distributor's metadata collection. This provides the benefit of increased sales and exposure.

However, as with all Web sites hoping to introduce the Internet public to their wares/content, potential customers need to know about the existence of the metadata server 212 of the content provider/distributor. To permit this to occur, when a content provider/distributor decides to become involved in the media browser/metadata server system 100, the content provider/distributor downloads a sample (customisable) metadata server from the primary media browser service provider. With this, the content provider can modify the sample metadata server from common platform to one that incorporates a specific translator for interfacing the XML Schema format to the database format used by the corresponding database manager to access the legacy database of the content provider. One of the options for the content provider, on configuring the sample metadata server, is to select to have their newly “customised” metadata server included as a link on the default TOC entry that is distributed with all media browser services. This means that the link to the new metadata server would appear on the default service at the primary media browser service provider and would be distributed with the media browser software to each of the secondary services. This provides for direct advertising of the content provider's wares. Clearly, users can then customise their own TOC when they begin working with the media browser service. However, an initial presence of the link on the entry TOC introduces the user to the metadata collection made visible via the newly linked metadata server.

In selecting to have a link to their metadata server included in the standard TOC, the content provider/distributor may agree to be billed a certain fee for each quanta of requests that their metadata server handles. This fee is typically very small (eg. US$1 for every 10,000 requests). Preferably the installed metadata server has an integrated billing mechanism which is responsible for keeping a tally of the number of requests and then periodically billing the content provider/distributor for the service. A credit card number to be charged may be stored in a secure fashion within the metadata server and billing is automatic and electronic.

In summary, the provision of a metadata server by the primary media browser service permits the content provider/distributor to provide an enhanced service and mechanism for advertising and selling multimedia content. The implementation of the metadata server effectively “opens up” the metadata collection of the content provider/distributor to a wider audience than that accustomed to simply visiting a search engine operated by the content provider/distributor. In addition the metadata browser/server system makes it more attractive for potential customers to browse/search the metadata because customers can perform these actions in a more convenient (ie. single interface) and time-efficient (ie. in parallel with other metadata collections) manner.

Taking the further step of using media browser services to effectively advertise their open metadata collection widens the potential customer base yet again. For this key additional advantage, the content provider/distributor undertakes to pay a small regular fee based on the number of requests their metadata server handles during a billing period. In the event that few requests are handled then costs charged to the content provider/distributor are small. This is a significant advantage, especially to smaller content providers.

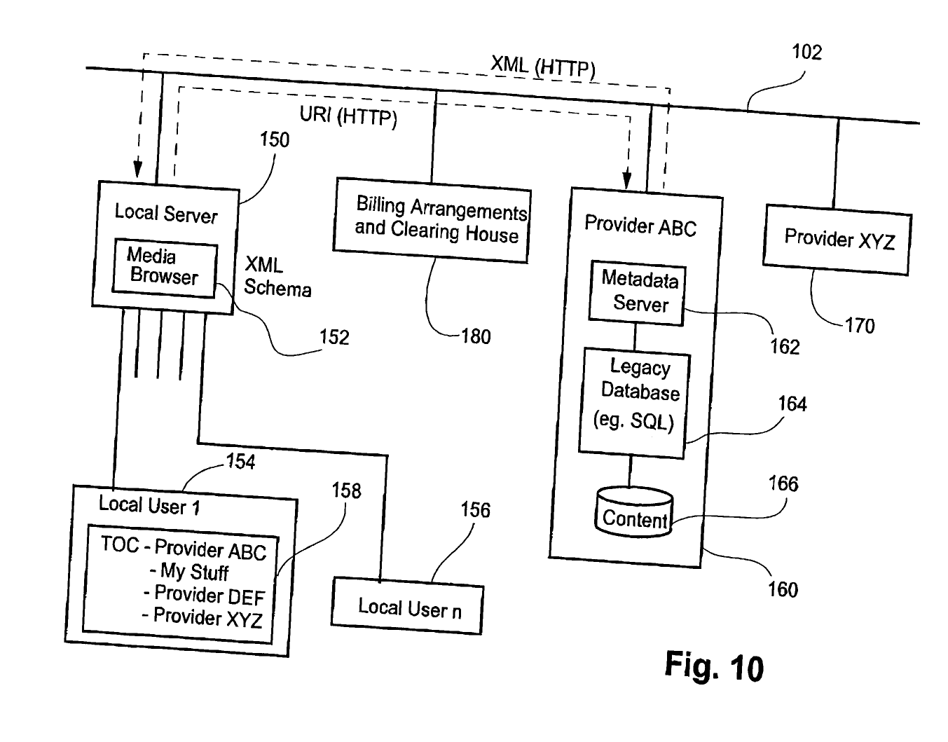

FIG. 10 shows an example implementation in which a local server 150 incorporates a media browser 152 as described above and which is available for use by a number of local users 154 . . . 156 connected to the local server 150. The local server 150 provides for connection between the users 154 . . . 156 and a number of content providers 160 and 170, as well as financial establishment 180, via the Internet 102. The providers 160 and 170 each incorporate a legacy database 164 and a corresponding store 166 of content. Typically the database 164 comprises an array of tables that maps references to content to locations of content within the store 166. A metadata server 162 is also provided and is configured to receive media browser requests transmitted as URI's according to HTTP, and generate XML descriptions to satisfy the media browser requests. With this arrangement, local users 154 . . . 156 having access to the media browser 152 are able to remotely access the content without having specific knowledge of, or using any call, commands or instructions unique to or associated with the legacy database 164. With such an arrangement, access for the user 154 to the content 166 may occur in a fashion transparent to nature of the database 164 (eg. whether the database is formed using SQL or dBase) whilst retaining the structural, organisational and searching attributes and functions of the database 164.

When performing a search for content across a number of content providers listed in a TOC 158, the local user 154 may, for example, be provided with positive returns for each of providers 160 and 170. At this stage, the proprietor of the local server 150 may invoice each of the providers 160 and 170 for a fee for “introducing” or facilitating access of the local user 150 to the content of each provider 160 and 170. Colloquially, this may be considered a “spotter's fee” and could be charged in a number of ways such as based on the number of searches delivering results, or the number of results delivered by any search, or simply the number of requests that the metadata server processes.

Where the local user 154 is desirous of purchasing content returned by provider 160, a financial transaction may be performed between the local user 154 and the provider 160, perhaps via the financial institution 180, and without affect on or influence by the local server 150. In an alternative approach, the local server 150 may be interposed as a financial intermediary whereby the provider 160 bill the local server 150 for the purchase of the content, and the local server 150 on-bills to the local user 154. Such an approach may be more convenient and provide enhanced security for transactions than the previous billing and payment arrangement. For example, where content returned by a searching session is desired to be purchased from a number of content providers 160 and 170, the local user need only perform a single transaction with the local server. Since those two parties have a pre-existing relationship, user identification may be more relaxed than if the user were to purchase directly from the provider, with whom no relationship may exist. The same issues apply to the relationship between the local server 150 and the providers 160 and 170.

Although the foregoing describes arrangements and implementations applicable respect to the provision of multimedia content, other goods and services may also be provided. For example, as seen in FIG. 1 where the link 118 is from the database 117 to physical goods, as opposed to multimedia content that may be downloaded electronically, the capacity of the user to enquire of the database 117, obtain a search result and ultimately perform a purchasing transaction remains.

Further, some implementations may have no commercial basis for a specific financial transaction. For example, patent offices worldwide may choose to make their proprietary databases available to the general public. Implementation of the media browser and servers described above enables this to be performed without a need for specially designed integration software, such as a web-page allowing a user query to be posted to more than one database. Such would therefore permit public access to a federation of distributed heterogenous databases.

VI. Alternative Structured Information Processing System

The description so far has been in reference to browsing and searching using metadata and then accessing associated content. It should be clear to those skilled in the art that many of the features described above also apply if the repository being accessed contains information that is not necessarily linked to particular items of content. For example, the equivalent of a metadata server, called here an information server, could also accept requests from a process for particular structured information that is stored in a source associated with the information server. The information source, like the metadata repository, could be publicly represented by a schema. The communication between the requesting process and the information server would be substantially as described in Section III of this description (i.e. browsing and search requests would be possible). The result of a request would be an XML document that represents structured information. An example of this more general implementation, given at the end of Section V, shows how users could potentially access different patent databases worldwide using a single user interface.

Clearly, the process of making requests of the information servers would operate somewhat differently, For example, the differentiation between TOC and index descriptors may no longer be useful. Instead the main feature of such structured information receiving processes could be to decorously format information from a variety of heterogeneous sources. For such an end objective, the ability to use the previously described advanced search, to selectively identify the information required is very useful. The results of any browsing and searching requests could be presented to the user in various formats depending on the data types involved and using predetermined formats that may or may not have been customised for a particular user.

Industrial Applicability

The arrangements and implementations described above are applicable to the computer and data processing industries and particularly those providing multimedia services. The implementations specifically provide for Internet service providers to add commercial value to the searching services they provide and/or host whilst facilitating the matching of vendors and purchasers of content.

The foregoing describes at least one embodiment of the present invention, and modifications and/or changes can be made thereto without departing from the scope and spirit of the invention, the embodiment(s) being illustrative and not restrictive.

We claim:

1. A system for facilitating access to descriptions of multimedia items from a plurality of content providers of said items, wherein information required by said descriptions is stored in corresponding metadata collections associated with said multimedia items, said system comprising:
(a) a metadata server associated with each said content provider and operable as a description-generating process for communicating with one or more description-receiving processes, each said metadata server being configured, for each said content provider, to perform the steps of:
(i) receiving a request for said descriptions from one of said description-receiving processes in a predetermined request format;
(ii) interpreting said received request according to said predetermined request format;
(iii) accessing said information about said multimedia items in said metadata collection of said content provider in response to said interpreted request;
(iv) formatting said accessed information as a description according to a predetermined scheme, said resulting description containing at least one link which represents a return request to said metadata server;
(v) sending said formatted description to the said description-receiving process; and
(b) at least one said description-receiving process accessible to and operable by potential customers of said content providers and providing said potential customers with a single user interface to access descriptions of multimedia items generated from said multiple metadata servers.

2. A system according to claim 1 wherein each said metadata collection is stored in a corresponding database.

3. A system according to claim 1 wherein each said metadata collection is stored in structured or semi-structured files.

4. A system according to claim 1 wherein said metadata server is identified by a uniform resource identifier.

5. A system according to claim 4 wherein said request to said metadata server is included in said uniform resource identifier identifying said metadata server.

6. A system according to claim 1 wherein said descriptions are in XML.

7. A system according to claim 1 wherein said predetermined scheme specifies the structure and syntax of said description.

8. A system according to claim 1 wherein said predetermined scheme is represented using the XML Schema language.

9. A system according to claim 1 wherein said link has a defined source and target.

10. A system according to claim 9 wherein said link source is an element containing the identity of said link target.

11. A system according to claim 10 wherein said link target is represented using a uniform resource locator.

12. A system according to claim 11 wherein said link target identifies the same metadata server that generated said link.

13. A system according to claim 1 further comprising a transaction module associated with an administrator of a corresponding said description-receiving process, said transaction module being configured to monitor a number of said requests made to any one said metadata server and to invoice the corresponding said content provider on behalf of said administrator for said number of requests.

14. A system according to claim 13 wherein said transaction module forms part of said one metadata server and said invoicing is automatically performed by the said metadata server.

15. A system according to claim 14 wherein the said automatic invoicing is enabled by storing a charge identification code for said corresponding content provider in said corresponding metadata server.

16. A system according to claim 15 wherein the charge identification code for said corresponding content provider is automatically accessible by said corresponding metadata server.

17. A system according to claim 1 wherein users of said description-receiving processes are presented with an option of following a provided link to a description-generating process, said provided link comprising an advertisement for said user.

18. A system according to claim 1 wherein each said metadata server is constructed from a common customisable module, each said module being customised for association with one said content provider by an interpreter arranged to translate requests received in said predetermined request format from any said description-receiving process into descriptions of said corresponding metadata items of said content provider and to translate said accessed information into said description-format for return to said description-receiving process.

19. A system for providing a plurality of users access to multimedia items associated with a plurality of content providers, each said content provider having a legacy database in which descriptions of corresponding said items are stored, a content database in which said corresponding multimedia items are stored, and a database manager for controlling access to said descriptions and corresponding multimedia items from said respective databases, said system comprising:
a media browser application accessible to each of said users and configured to generate user requests for descriptions of said multimedia items, said requests being generated in a predetermined request format;
a metadata server application associated with each said content provider and configured to translate each said user request received by said metadata server from said predetermined request format into a specific format of said database manager to thereby provide for said database manager to query said legacy database and return at least one response description to said metadata server, said metadata server translating said at least one response description into said predetermined description format and returning the translated description to the requesting said media browser for presentation to said user.

20. A system according to claim 19 further comprising a request transaction module associated with an administrator of said media browser, said request transaction module being configured to monitor a number of said requests made to any one said metadata server and to invoice the corresponding said content provider on behalf of said administrator for said number of requests.

21. A system according to claim 19 wherein said media browser comprises a user interface configured for presenting said translated description to said user, said system further comprising a user transaction module by which said user may access, for consideration provided to said content provider, at least one said multimedia item from said presented description.

22. A system according to claim 19 wherein said descriptions are in XML.

23. A system according to claim 21 wherein said user interface comprises a multimedia user interface arranged to reproduce at least part of said multimedia item from said returned description.

24. A system according to claim 21 wherein said item comprises an image and said part comprises one of a thumbnail or low-resolution representation of said image.

25. A system for facilitating access to structured information from a plurality of heterogeneous information sources, said system comprising:
(a) an information server associated with each said information source and operable as a structured information generating process for communicating with one or more structured information receiving processes, each information server being configured to perform, for an information source, the steps of:
(i) receiving a request for said structured information from one of said structured information receiving processes in a predetermined request format;
(ii) interpreting said received request according to said predetermined request format;
(iii) accessing information in said associated information source in response to said interpreted request;
(iv) formatting said accessed information as said structured information according to a predetermined scheme, said resulting structured information containing at least one link which represents a return request to said information server;
(v) sending said structured information to said structured information receiving process; and
(b) at least one structured information receiving process accessible to and operable by potential users of said information sources with a single user interface to access and interpret said structured information from said multiple information servers.

26. A system according to claim 25 wherein said information source is a database.

27. A system according to claim 25 wherein said information source is a collection of structured or semi-structured information files.

28. A system according to claim 25 wherein said information server is identified by a uniform resource identifier.

29. A system according to claim 28 wherein said request to said information server is included in the uniform resource identifier identifying the said information server.

30. A system according to claim 25 wherein said structured information is in XML.

31. A system according to claim 25 wherein said predetermined scheme specifies the structure and syntax of the said structured information to be generated.

32. A system according to claim 25 wherein said predetermined scheme is represented using the XML Schema language.

33. A system according to claim 25 wherein said link has a defined source and target.

34. A system according to claim 33 wherein said link source is an element containing the identity of said link target.

35. A system according to claim 34 wherein said link target is represented using a uniform resource locator.

36. A system according to claim 35 wherein said link target identifies the same information server that generated the said link.

37. A metadata server operable as a description-generating process for communicating with one or more description-receiving processes, said metadata server being configured to perform the steps of:
(i) receiving a request for descriptions of multimedia items from one of said description-receiving processes in a predetermined request format, wherein information required by said descriptions is stored in corresponding metadata collections associated with said multimedia items;
(ii) interpreting said received request according to said predetermined request format;
(iii) accessing said information about said multimedia items in said metadata collection of said content provider in response to said interpreted request;
(iv) formatting said accessed information as a description according to a predetermined scheme, said resulting description containing at least one link which represents a return request to said metadata server; and
(v) sending said formatted description to the said description-receiving process.

38. A metadata server according to claim 37 wherein each said metadata collection is stored in a corresponding database.

39. A metadata server according to claim 37 wherein each said metadata collection is stored in structured or semi-structured files.

40. A metadata server according to claim 37 wherein said metadata server is identified by a uniform resource identifier.

41. A metadata server according to claim 40 wherein said request to said metadata server is included in said uniform resource identifier identifying said information server.

42. A metadata server according to claim 37 wherein said descriptions are in XML.

43. A metadata server according to claim 37 wherein said predetermined scheme specifies the structure and syntax of said description.

44. A metadata server according to claim 37 wherein said predetermined scheme is represented using the XML Schema language.

45. A metadata server according to claim 37 wherein said link has a defined source and target.

46. A metadata server according to claim 45 wherein said link source is an element containing the identity of said link target.

47. A metadata server according to claim 46 wherein said link target is represented using a uniform resource locator.

48. A metadata server according to claim 47 wherein said link target identifies the same metadata server that generated the said link.

49. An information server operable as a structured information generating process for communicating with one or more structured information receiving processes, said information server being configured to perform the steps of:
(i) receiving a request for said structured information from one of said structured information receiving processes in a predetermined request format;
(ii) interpreting said received request according to said predetermined request format;
(iii) accessing information in response to said interpreted request;
(iv) formatting said accessed information as said structured information according to a predetermined scheme, said resulting structured information containing at least one link which represents a return request to said information server; and
(v) sending said structured information to said structured information receiving process.

50. An information server according to claim 49 wherein said information source is a database.

51. An information server according to claim 49 wherein said information source is a collection of structured or semi-structured information files.

52. An information server according to claim 49 wherein said information server is identified by a uniform resource identifier.

53. An information server according to claim 52 wherein said request to said information server is included in the uniform resource identifier identifying the said information server.

54. An information server according to claim 49 wherein said structured information is in XML.

55. An information server according to claim 49 wherein said predetermined scheme specifies the structure and syntax of the said structured information to be generated.

56. An information server according to claim 49 wherein said predetermined scheme is represented using the XML Schema language.

57. An information server according to claim 49 wherein said link has a defined source and target.

58. An information server according to claim 57 wherein said link source is an element containing the identity of said link target.

59. An information server according to claim 58 wherein said link target is represented using a uniform resource locator.

60. An information server according to claim 59 wherein said link target identifies the same information server that generated t he said link.

61. A computer readable medium, having a program recorded thereon, where the program is configured to make a metadata server operable as a description-generating process for communicating with one or more description-receiving processes, said program comprising:
code for receiving a request for descriptions of multimedia items from one of said description-receiving processes in a predetermined request format, wherein information required by said descriptions is stored in corresponding metadata collections associated with said multimedia items;
code for interpreting said received request according to said predetermined request format;
code for accessing said information about said multimedia items in said metadata collection of said content provider in response to said interpreted request;
code for formatting said accessed information as a description according to a predetermined scheme, said resulting description containing at least one link which represents a return request to said metadata server; and
code for sending said formatted description to the said description-receiving process.

62. A computer readable medium, having a program recorded thereon, where the program is configured to make an information server operable as a structured information generating process for communicating with one or more structured information receiving processes, said program comprising:
code for receiving a request for said structured information from one of said structured information receiving processes in a predetermined request format;
code for interpreting said received request according to said predetermined request format;
code for accessing information in response to said interpreted request;
code for formatting said accessed information as said structured information according to a predetermined scheme, said resulting structured information containing at least one link which represents a return request to said information server; and
code for sending said structured information to said structured information receiving process.
